(19) United States
(12) Patent Application Publication
(10) Pub. No.: US 2004/0123726 A1
(43) Pub. Date: Jul. 1, 2004

(54) Performance evaluation apparatus and a performance evaluation program

(75) Inventors: Hitoshi Kato, Tokyo (JP); Akinori Matsubara, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/735,510

(22) Filed: Dec. 11, 2003

(30) Foreign Application Priority Data
Dec. 24, 2002 (JP) 2002-371189
Jan. 20, 2003 (JP) 2003-10886
Feb. 20, 2003 (JP) 2003-42546
Apr. 3, 2003 (JP) 2003-99864

(51) Int. Cl. A63H 5/00; G04B 13/00; G10H 7/00

(52) U.S. Cl. 84/609

(57) ABSTRACT

CPU works in accordance with a program stored on program ROM to set a performance evaluation period based on contents of music data for evaluation stored on a music memory. CPU evaluates performance of music data in every predetermined period and displays the evaluation results on a display device. When a user plays a music piece for evaluation, the user's performance technique is evaluated correctly, and it is expected that the user's performance technique is improved efficiently.

### BACKGROUND OF THE INVENTION

1. Field of the Invention

The present invention relates to a performance evaluation apparatus and a performance evaluation program for evaluating a user's performance in practice.

2. Description of the Related Art

An electronic musical instrument with a system for evaluating musical performance has been proposed. The electronic musical instrument keeps reference-performance data stored therein, and compares performance data of actual performance with the reference-performance data to evaluate the actual performance. In the instrument, to compare the actual performance and the reference performance, it is judged whether or not a played pitch and key coincide with a pitch and a key designated in the reference-performance data, or it is judged whether or not the time at which the key is played in the actual performance coincides with a time designated in the reference-performance data.

To compare both the pitches, it is judged whether or not a correct key of the keyboard or a correct manipulation member has been played, and further judged whether the key or the manipulation member is operated at the correct time or not.

In the conventional technology set forth above, to evaluate the pitch, it is judged simply whether or not the manipulation member corresponding to the pitch designated in the reference data has been played. To evaluate performance timing, it is necessary to judge whether the at which the key is played coincides with the time designated in the reference-performance data, and further to judge whether the time at which the key is played falls within an allowance range which is carefully decided previously. To carry out these judging operations, a timing difference between the time designated in the reference-performance data and the time at which the key is actually played must be detected and further in consideration that the keys will be played faster,

the reference data must be read out before the actual performance is given.

If CPU is imposed to perform the operations set forth above in addition to perform various processes essential to the features of the electronic musical instrument, too heavy load is applied to CPU. When processing music data of a fast tempo, such CPU can not finish processing of such music data, causing the performance of the music data to be delayed.

Apart from the field of practice of the musical instrument performance, as a conventional technology similar to the performance evaluation apparatus, so-called karaoke system has been proposed. The karaoke system has a scoring function for evaluating singing to the accompaniment of karaoke music. The karaoke system receives an audio signal of singing to the accompaniment of karaoke music, and analyzes the audio signal to extract frequency components and sound volume, scoring the singing in real time based on these extracted data. The extracted frequency data, sound volume data, etc are compared with guide melody data of the karaoke music to determine whether these data coincide with each other or not for scoring purpose.

In the conventional technology, an evaluation starts from the beginning of the guide melody data independently of contents of a karaoke music. Since the beginning parts of the karaoke music, which are most difficult mentally as well as in skill level are used to evaluate the singing, a user or a singer who failed in the beginning receives a low rating and will be evaluated, for example, as “out of tune”, “tempo off” and/or “muffled voice”. Thereafter, it is often likely that the karaoke music has come to end, before he or she gets out of his or her bad condition.

It is hard even for not a beginner to start singing a song in synchronization with the beginning of a karaoke music. It is usual for most of people to start singing before or after the beginning of the karaoke music. When the singer starts singing a little after the beginning of the karaoke music, he or she has a chance to receive somewhat a high rating, but on the contrary when the singer starts singing a little before the beginning of the karaoke music, he or she has not a chance to receive a high rating.

The above situation is not only for singing a song in karaoke but may be much the same for the musical instrument performance. For instance, when the user or the practitioner plays a study with an electronic keyboard instrument for evaluation, it is hard for the practitioner to keep the timing at the beginning part of the study. Only a few beginners can start performance smoothly. Therefore, when the practitioner's performance of the study from the very beginning to the end is evaluated, he or she will receive a too low rating. Further, it is determined depending on the contents of the study whether it is easy or hard to play the beginning part of the study. Unlike in the case of a singing competition, when the practitioner plays the study for evaluation as part of the musical training, it is the important purpose to improve performance technique of the practitioner. Therefore, the conventional apparatus or technology can disturb progress in the practitioner's performance technology.

In the case that a pitch of a sound-generation event contained in the music data and a sounding period defined by the time of initiating sound-generation and the time of vanishing sounding are designated, when the practitioner should have started performance before the time of initiating sound-generation, his or her performance will be subjected to deduction of the scoring point whether the time difference is long or short. In case that, following the notes contained in music data, the practitioner plays the study in accordance with the sounding period, even though the designated time of initiating sound generation substantially coincides with the time of initiating performance, his or her performance will be subjected to deduction of the scoring point when the practitioner should start performance a little before the designated time of initiating sound-generation. As the result, the practitioner's performance technique is not evaluated correctly, and the conventional evaluating manner set forth above is not preferable for improving the practitioner's technique.

Further, when the user or the practitioner plays a study for evaluation with an electronic keyboard instrument, it is hard for the practitioner to keep the timing at the beginning part of the study or a part of the study where a tempo is changed to a different tempo or a key is modulated, or at a part where a phrase of a melody line is greatly changed. Only a few beginners can start performance smoothly. The practitioner often gets too nervous to play the keys, and receives an unexpected low rating. The practitioner not only loses confidence but also has no interest and willingness to play an instrument.

Therefore, unlike in the case of a singing competition, when the practitioner plays the study for evaluation as part of the musical training, the practitioner can not receive support or assistance in improving his or her playing technique with the conventional technology set forth above.

### SUMMARY OF THE INVENTION

The present invention has been made to solve the problems set forth above, and has an object to provide a performance evaluation apparatus and a performance evaluation program, which imposes no heavy evaluation process onto CPU and allows a performance evaluation without using CPU of a high price.

Other object of the invention is to provide a performance evaluation apparatus and a performance evaluation program, which is used by a user who plays a music piece for evaluation to evaluate his or her own performance technique correctly to improve his or her performance technique efficiently.

Still other object of the invention is to provide a performance evaluation apparatus and a performance evaluation program, which is used by a user who plays a music piece for evaluation to receive supports to make him or her feel less tight to play the music piece, improving his or her performance technique more efficiently.

Another object of the invention is to provide a performance evaluation apparatus and a performance evaluation program, which is used to evaluate the user's own performance technique correctly to improve his or her performance technique more efficiently, when a user is in practice at performing a music for evaluation.

According to one aspect of the invention, the reference-performance data prepared for designating a pitch of a musical sound for generating a sound, a time at which a sound of the musical sound should be generated and a time at which the sound of the musical sound should be vanished are successively supplied, and actual-performance data including a time of instructing to generate a sound of a musical sound at the designated pitch and a time of instructing to vanish the sound of the musical sound are successively supplied.

Further, a reference on-period indicative of a period between the time at which the sound of the musical sound should be generated and the time at which the sound of the musical sound should be vanished is extracting from the supplied reference-performance data, and a real on-period indicative of a period between the time of instructing to generate the sound of the musical sound and the time of instructing to vanish the sound of the musical sound is extracted from the supplied actual-performance data.

It is judged whether the extracted reference on-period and extracted the real on-period overlap with each other or not. Only when it is determined that the reference on-period and the real on-period overlap with each other, the pitch of the sound generated in the reference on-period is compared with the pitch of the sound generated in the real on-period. When it is determined that both the pitches are the same, an evaluation point is added to an evaluation score, and meanwhile, when it is determined that both the pitches are not the same, the evaluation point is subtracted from the evaluation score.

With the configuration set forth above, there is no need to detect a timing difference between the time of the reference performance and the time of the real performance, or to read the reference-performance data in advance, which detecting operation or data reading operation is required in a conventional technique. Therefore, no heavy operation is imposed on CPU for performance evaluation. In addition, only when a player makes a performance, evaluation score is calculated to add an evaluation point or to subtract the evaluation point. As the result, only the player's performance is evaluated.

According to another aspect of the invention, an evaluation period is set in accordance with contents of music data to be performed, and performance of the music data in every predetermined period within the evaluation period is evaluated. The results of evaluation are displayed on a display device.

With the configuration set forth above, a period which is not appropriate for evaluation is excluded form the evaluation period. The user's performance technique is evaluated correctly and prompt progresses in performance technique are expected.

According to still another aspect of the invention, performance of the music data is evaluated in an evaluation period set in accordance with contents of music data to be performed, and a non-performance state is detected, during which non of notes to be played in the evaluation period is played. Supports are provided for the result of evaluation and the detected non-performance state.

With the configuration set for above, when the non-performance state is detected during which non of notes is played, supports are provided to the user, which make the user feel less tight and keeps him or her from the non-performance state. The user is supported effectively to improve his or her performance technique.

According to other aspect of the invention, a pitch of a sound-generation event contained in music data and a sound-generation period between a time of initiating sound generation and a time of vanishing the sound generation are designated, and a pitch of a performed musical sound and a time of initiating performance of the musical sound are detected. It is judged whether or not the detected pitch of the performed musical sound coincides with the designated pitch of the sound-generation event. It is determined that there is a coincidence in timing, when the time of initiating performance is detected within the designated sound-generation period, or when the time of initiating sound generation is designated within a predetermined time period after the time of initiating performance, and in other case, it is determined that there is no coincidence in timing. When it is determined that the detected pitch of the performed musical sound coincides with the designated pitch of the sound-generation event, and when it is determined that there is a coincidence in timing, an evaluation point is added to the evaluation score. When it is determined that the detected pitch of the performed musical sound does not coincide with the designated pitch of the sound-generation event or when it is determined that there is no coincidence in timing, the evaluation point is subtracted from the evaluation score.

With the configuration set forth above, when the user performs the music for evaluation, the user's performance technique is evaluated correctly, and therefore the user's performance technique is expected to be improved effectively.

### BRIEF DESCRIPTION OF THE DRAWINGS

FIG. 1 is a block diagram illustrating a configuration of a performance evaluation apparatus in embodiments of the present invention;

FIG. 2 is a main flow chart showing a performance evaluation procedure performed in a first embodiment;

FIG. 3 is a flow chart of a switching process in the first embodiment;

FIG. 4 is a flow chart of the music selecting process in the first embodiment;

FIG. 5 is a flow chart of a start/stop switching process in the first embodiment;

FIG. 6 is a flow chart of an automatic performance process in the first embodiment;

FIG. 7 is a flowchart showing apart of the automatic performance process shown in FIG. 6;

FIG. 8 is a flowchart showing apart of the automatic performance process shown in FIG. 6;

FIG. 9 is a flow chart of a keyboard process in the first embodiment;

FIG. 10 is a flow chart of a part of an evaluation process in the first embodiment;

FIG. 11 is a flow chart of a part of the evaluation process in the first embodiment;

FIG. 12 is a view showing a graph of evaluation measures versus evaluation levels in the first embodiment;

FIG. 13 is a timing chart view illustrating a relationship in timing between guide notes and played notes;

FIG. 14 is a flow chart of the start/stop switch process in a second embodiment;

FIG. 15 is a flow chart of a part of an automatic performance process in the second embodiment;

FIG. 16 is a flow chart of a part of the automatic performance process in the second embodiment;

FIG. 17 is a flow chart of a start/stop process in a third embodiment;

FIG. 18 is a flow chart of an automatic performance process in the third embodiment;

FIG. 19 is a flow chart of an evaluation process in the third embodiment;

FIG. 20 is a graph showing an example of evaluation measures versus evaluation levels.

FIG. 21 is a flow chart of a music selecting process in a fourth embodiment;

FIG. 22 is a flow chart of a part of the music selecting process following the process shown in FIG. 22;

FIG. 23 is a flow chart of a music selecting process in a fifth embodiment;

FIG. 24 is a flow chart of the automatic performance process shown in FIG. 2;

FIG. 25 is a flow chart of the automatic performance process following the process shown in FIG. 24;

FIG. 26 is a flow chart of the automatic performance process following the process shown in FIG. 25;

FIG. 27 is a flow chart of the automatic performance process following the process shown in FIG. 26;

FIG. 28 is a flow chart of the automatic performance process following the process shown in FIG. 27;

FIG. 29 is a flow chart of the keyboard process shown in FIG. 2;

FIG. 30 is a flow chart of the keyboard process following the process shown in FIG. 29;

FIG. 31 is a flow chart of the keyboard process following the process shown in FIG. 30;

FIG. 32 is a flow chart of a timer interrupt;

FIG. 33 is a flow chart of the evaluation process shown in FIG. 2;

FIG. 34 is a flow chart of the evaluation process following the process shown in FIG. 33;

FIG. 35 is a view illustrating by way of example the played keys and performance guidance of a chord.

FIG. 36 is a view illustrating by way of example the played keys and performance guidance of plural notes each of a different time of initiating sound generation; and

FIG. 37 is a view illustrating by way of example a case in which no key is played meanwhile there is given performance guidance of plural notes each of a different timing for the initiation of sound generation.

### DETAILED DESCRIPTION OF THE PREFERRED EMBODIMENTS

Now, performance evaluation apparatuses according to a first embodiment through a fifth embodiment of the present invention will be described with reference to the accompanying drawings.

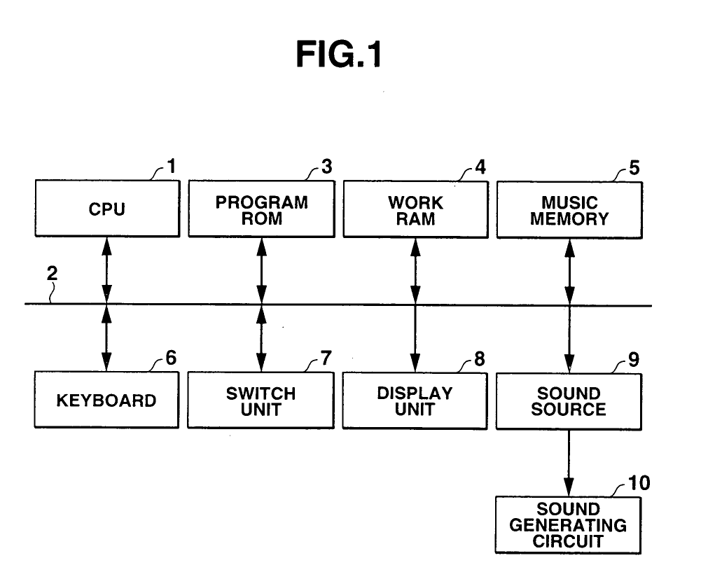

FIG. 1 is a block diagram illustrating a configuration of a system in the performance evaluating apparatus according to the embodiments. In FIG. 1, CPU 1 is connected with peripheral units, including a program ROM 3, a work RAM 4, a music memory 5, a keyboard 6, a switch unit 7, a display unit 8 and a sound source 9, through a system bus 2, and exchanges commands and data with these peripheral units to control the whole operation of the performance evaluation apparatus 1.

On the program ROM 3 are previously stored a control program which CPU 1 executes, an application program such as a performance evaluation program and initial data used during a start-up initialization. The work RAM 4 has areas for various registers and flags which are necessary for executing the programs. On the music memory 5 are stored plural music data for an automatic performance, the performance of which music data is evaluated. The keyboard 6 inputs key numbers and velocities to CPU 1 as a music piece is being played. The switch unit 7 includes a switch which is used to select a music piece from among those stored in the music memory 5 and a start/stop switch which is manipulated for starting or stopping the automatic performance.

The display unit 8 displays music of a music piece to be automatically performed, which performance is evaluated, and a result of the evaluation. The sound source 9 is connected to a sound generating circuit 10, and generates cheers for a performer and other sound signal in response to a note-on command or a note-off command from CPU 1 to supply then to the sound generating circuit 10. The sound generating circuit 10 includes a D/A converter, a filter, an amplifier, and a speaker, and outputs a musical sound in accordance with the sound signal supplied from the sound source 9.

Each key of the keyboard 6 is provided with LED indicator (or a guide indicator)(not shown), which is turned on to give a guidance in accordance with a performance instruction by CPU 1.

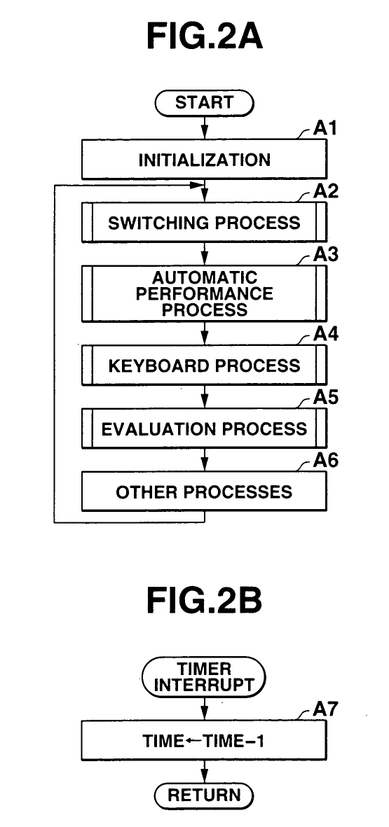

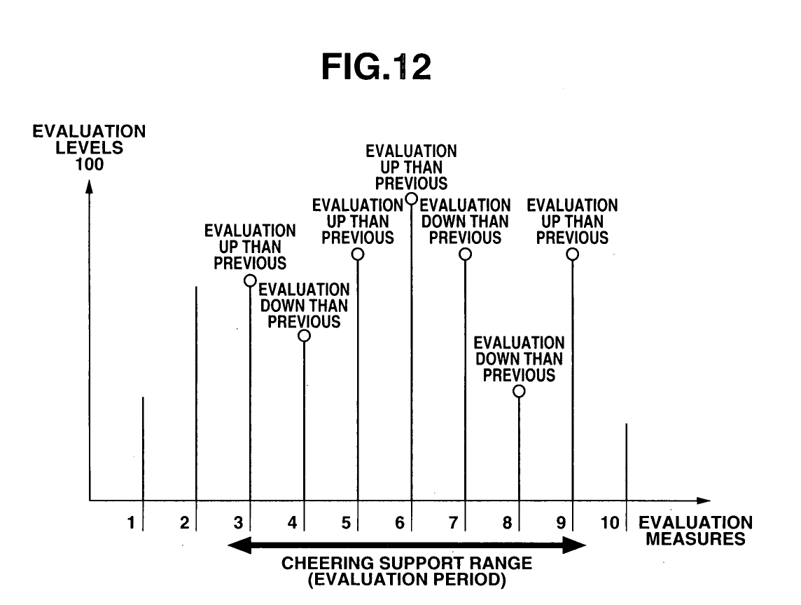

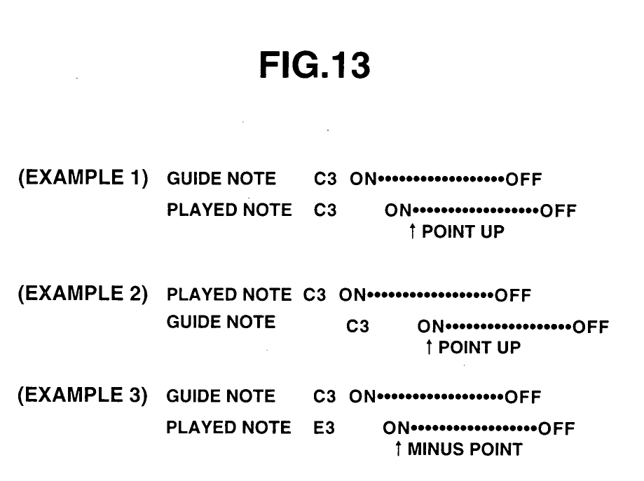

An operation of the performance evaluation apparatus according to the first embodiment will be described with reference to flow charts of operations performed by CPU 1 shown in FIGS. 2A and 2B through FIG. 11 and views shown in FIG. 12 and FIG. 13.

FIG. 2A is a main flow chart of a performance evaluation procedure performed by CPU 1, and FIG. 2B is a flow chart of a timer interrupt. CPU 1 performs processes in accordance with the flow chart of FIG. 2A and performs an initializing process at Step A1 to clear various registers in the work RAM 4, to reset various flags, and to prohibit the timer interruption. After the initialization has been performed, a switching process is performed at Step A2 to detect whether each switch in the switch unit 7 is on or off, and an automatic performance process is carried out at Step A3 to read out music data of an evaluation music which is selected from among those stored in the music memory 5 to give a performance instruction. Further, a keyboard process is carried out at Step A4 to scan the keys of the keyboard 6, detecting a performance on the keyboard or detecting played keys and released keys, and an evaluation process is performed at Step A5 to evaluate the performance of the evaluation music, and further other process is performed at Step A6. These processes are repeatedly carried out at Step A2 through Step A6.

In FIG. 2B, when a timer interrupt is carried out every preset constant time period, a value of a register TIME is decremented at Step A7 as will be describe later, and the procedure returns to the main procedure or the main flow chart shown in FIG. 2A.

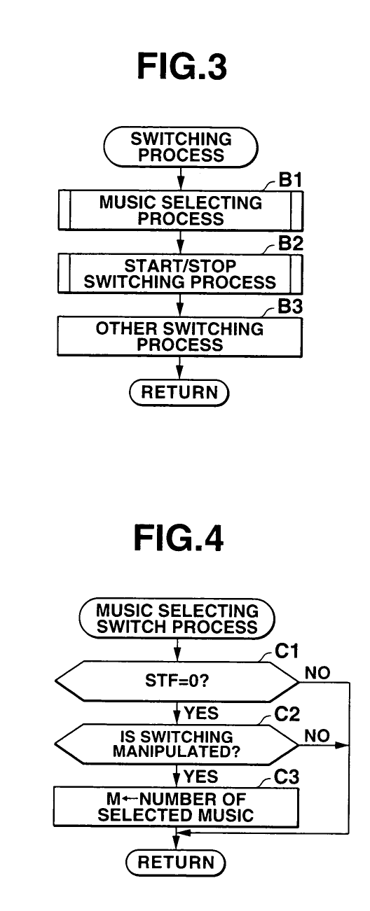

FIG. 3 is a flow chart of the switching process performed at Step A2 in the main flow chart. At Step B1, a music selecting process is performed, and then a start/stop switching process is carried out at Step B2, and further other switching process is performed at Sep B3. Then, the procedure returns to the main flow chart.

FIG. 4 is a flow chart of the music selecting process performed at Step B1 in the switching process. It is judged at Step C1 whether a start flag STF has been set to “0” (a performance stoppage) or not. When the start flag STF has been set to “1” (automatic performance), the process is suspended. When the start flag STF has been set to “0”, it is judged at Step C2 whether or not a switch is manipulated to select a music piece. When the switch is not manipulated, the process is suspended. When the switch is manipulated, the number of the music selected by manipulation of the switch is stored on a register M at Step C3. The procedure in the flow chart of FIG. 4 ends.

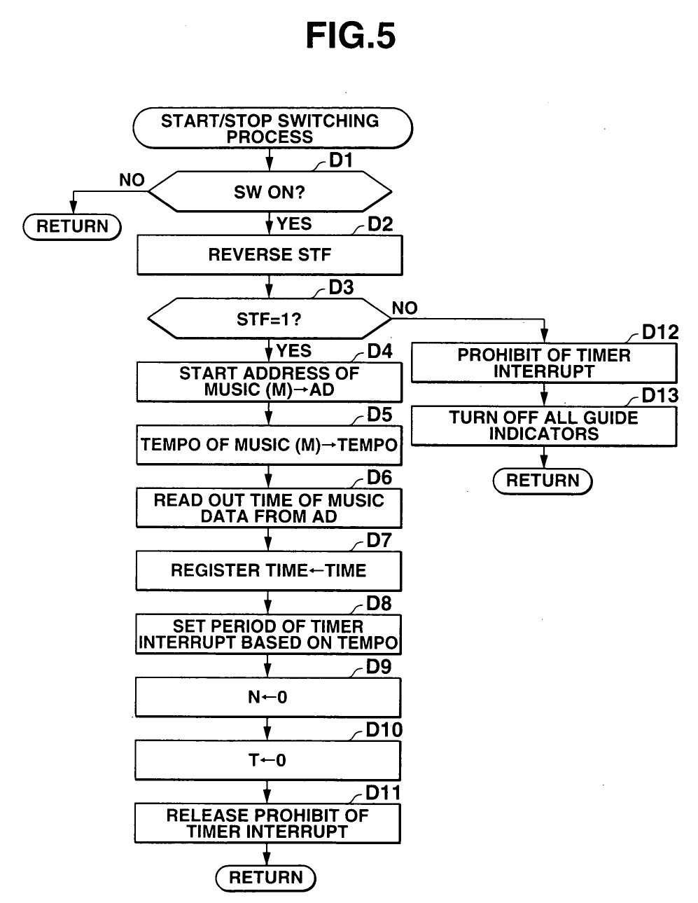

FIG. 5 is a flow chart of the start/stop switching process carried out at Step B2 in the flow chart shown in FIG. 3. It is judged at Step D1 whether or not a start/stop switch has been turned on. When the start/stop switch has not been turned on, the process is suspended. When the start/stop switch has been turned on, a value of the flag STF is reversed at Step D2. At next step D3, it is judged at step D3 whether or not it is true that the value of the flag STF is “1”. When the value of the flag STF is “1”, the automatic performance is automatically performed, and the start address of the music piece (M) designated by the music number stored in the register M is stored on a register AD at step D4. Further, a tempo of the music piece (M) is stored on a tempo register TEMPO at step D5.

A time of the music data at the start address designated by the register AD is read out at step D6 and stored on a register TIME at step D7. At step D8, a time period of the timer interrupt is set based on the tempo stored on the register TEMPO. Then, a register N is cleared to “0” at step D9. The register N counts the number of note symbols from the beginning of the music piece as the music piece is performed. A register T is cleared to “0” at step D10. The register T counts a predetermined number of note symbols for evaluating the performance. Then, the prohibit of the timer interrupt is released at step D11. A described above, the value of the register TIME is decremented every time period based on the tempo stored on the register TEMPO.

When it is determined at step D3 that the register STF is reversed from “1” to “0”, the time interrupt is prohibited at step D12, and all the LED indicators prepared for giving a guidance on the keyboard 6 are turned off at step D13, since the automatic performance is suspended. Then procedure returns to the main process or the main flow chart.

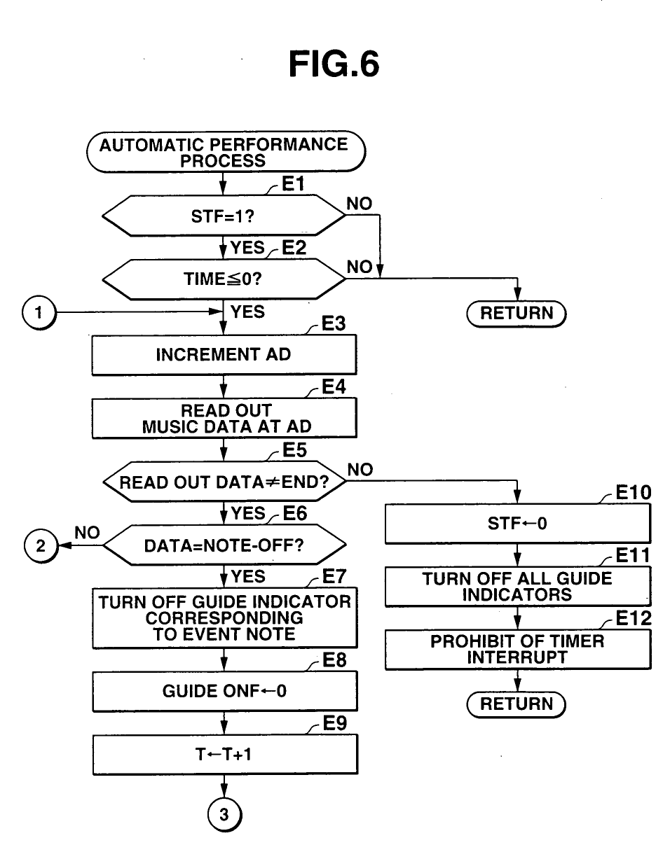

Details of the automatic performance process at Step A3 in the main flow chart are shown in FIG. 6 through FIG. 8. At step E1, it is judged whether or not it is true that the register STF is set to “1”. When the register STF is set to “1”, or when the automatic performance is being carried out, it is judged at step E2 whether or not the value of the register TIME that is decremented every timer interrupt has reached “0”. When the register TIME has reached “0”, the address on the register AD is incremented at step E3 to read the next music data, and the music data is read out in accordance with the address on the register AD at step E4.

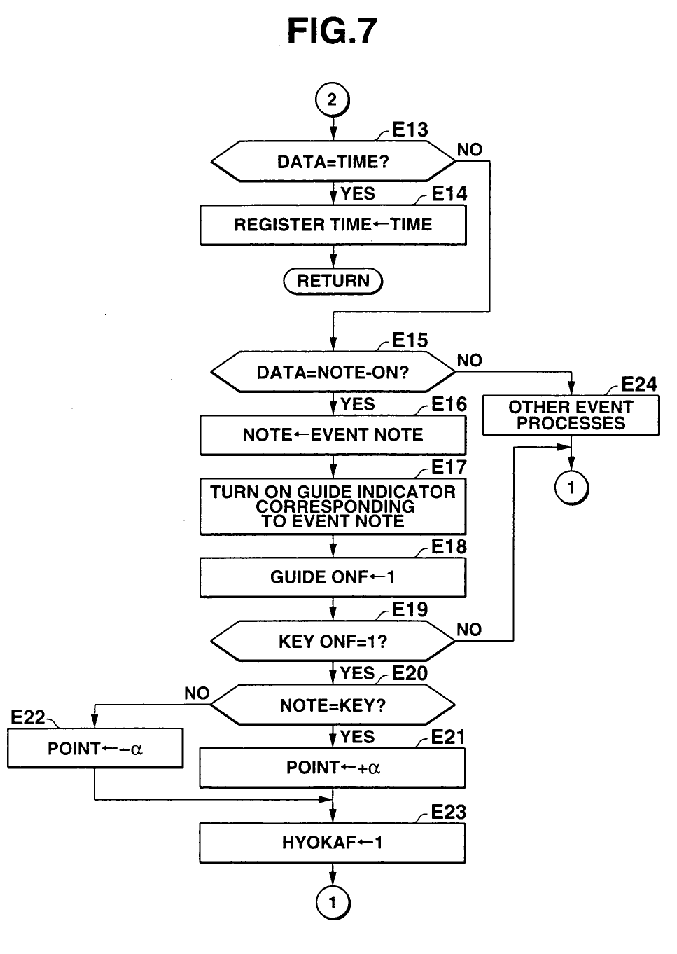

Then, it is judged at step E5 whether or not the read out music data represents END of the music piece. When the music data does not represent END of the music piece, it is judged at step E6 whether or not the music data is a note-off event. When the music data is not a note-off event, it is judged at step E13 (FIG. 7) whether or not the data represents a time. When the data represents a time, the time is stored on the register TIME at step E14, and the procedure ends.

When the data does not represent a time, it is judged at Step E15 whether or not the music data is a note-on event. When the music data is a note-on event, a note of the event is stored on a register NOTE at step E16. Then, the guide indicator in the keyboard 6 which corresponds to the note of the event is turned on at step E17, and further a guide flag GUIDE ONF is set to “1” at step E18. At step E19, it is judged whether a flag KEY ONF is set to “1” (a played key).

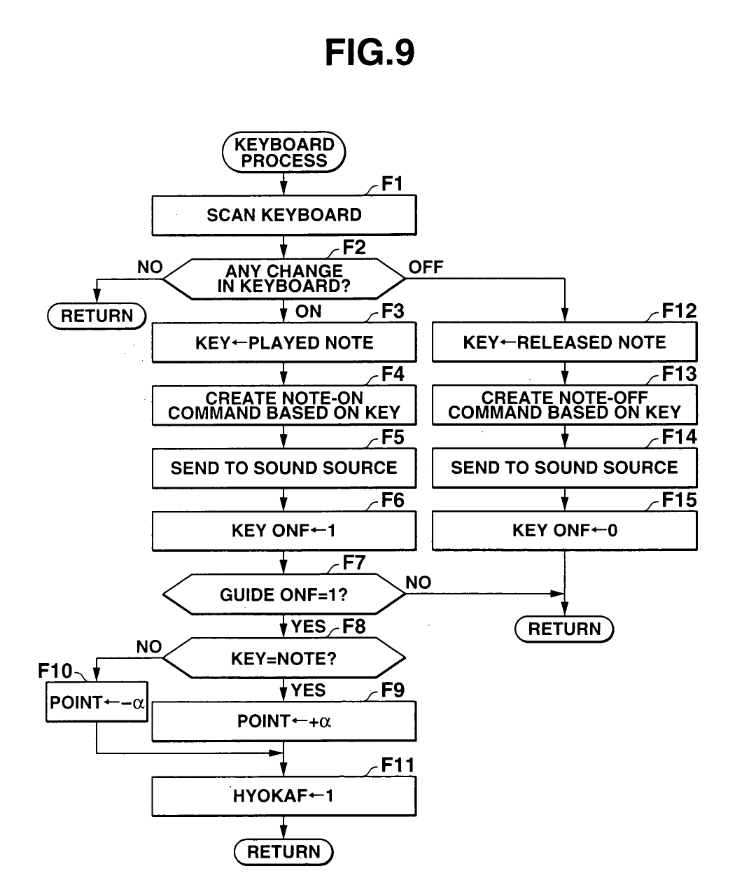

When the flag KEY ONF is set to “1”, KEY ONF indicates that a key of the keyboard 6 is played (or depressed). Then, it is judged at step E20 whether or not the note of the event stored on the register NOTE coincides with a note which is stored on a register KEY in a keyboard process (FIG. 9) to be described later. When the note of the register NOTE and the note of the register KEY coincide with each other, or in case a key indicated to be played has been played when GUIDE ONF is set to “1”, a value of “alpha” is added to a value of a register POINT at step E21. When the note of the register NOTE and the note of the register KEY do not coincide with each other, a value of “alpha” is subtracted from the value of the register POINT at step E22 After the addition or the subtraction of “alpha” has been carried out, an evaluation flag HYOKAF is set to “1” at step E23. When it is determined at step E15 that the data is not the a note-on event, other event process is performed at step E24.

In case that the flag KEY ONF holds “0” at step E19 after the flag HYOKAF has been set to “1” at step E 23, or after other event process has been carried out at step E24, the procedure advances to step E3 (FIG. 6), where the register AD is incremented.

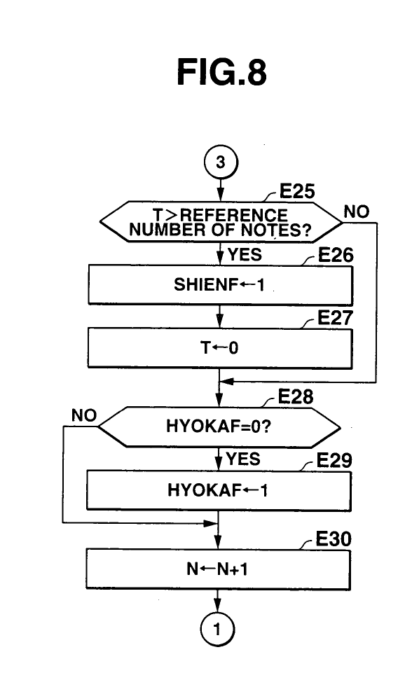

When it is determined at step E6 that the music data read out at step E4 (FIG. 6) is the note-off event, the guide indicator for the key corresponding to the note of the event is turned off at step E7. Then, the guide flag GUIDE ONF is reset to “0” at step E8. Since a process has been completed with respect to one note during the predetermined time period for evaluation, the note number of the register T is incremented at step E9, and then it is judged at step E25 (FIG. 8) whether or not the note number of the register T has reached a reference number of notes.

When the note number of the register T has reached the reference note number, a flag SHIEN is set to “1” (support) at step E26, and the note number of the register T is cleared to “0” at step E27. The flag SHIEN indicates whether support with cheers and/or indications should be given to a user or a player. After the register T has been cleared, or when it is determined at step E25 that the note number of the register T has not reached the reference note number, it is judged at step E28 whether or not the flag HYOKAF holds “0”. When the flag HYOKAF holds “0”, same is set to “1” at step E29. When the flag HYOKAF has been set to “1” or holds “1”, the register N, which stores the number of notes contained in the music piece counted from the beginning is incremented at step E30. Then, the procedure advances to step E3 (FIG. 6), where the address of the register AD is incremented.

At step E5 (FIG. 6) it is determined that the read out music data represents END, the flag STF is reset to “0” at step E10 and all the guidance indications for the keyboard 6 are turned out at step E11. Further, the timer interrupt is prohibited at step E12 and the procedure of the flowchart shown in FIG. 6 is terminated and the procedure returns to the main procedure shown in FIG. 2A.

FIG. 9 is a flow chart showing the keyboard process at step A4 in the main flow chart of FIG. 2A. At step F1 (FIG. 9), keys of the keyboard 6 are scanned at step F1 to detect any change in the keys of the keyboard 6 at step F2. When no change in the keyboard 6 is confirmed, the procedure is suspended and returns to the main procedure of FIG. 2A. When the keyboard 6 is changed form “off” to “on”, that is, when any key of the keyboard 6 is played, the note corresponding to the played key is stored on the register KEY at step F3, and a note-on command is produced based on the note of the register KEY at step F4. The note-on command is sent to the sound source 9 at step F5 and the flag KEY ONF is set to “1” at step F11.

At step E7 it is judged whether or not the guide flag GUIDE ONF holds “1”. When the guide flag GUIDE ONF holds “0”, the procedure returns to the main procedure shown in FIG. 2A. When the flag holds “1” and the guide indicator is turned on to indicate a key to be played, it is judged at step F8 whether or not the note stored on the register KEY coincides with the note indicating a key to be played and stored on the register NOTE. When both the notes coincide with each other, that is when the key indicated by the note is played correctly, a value of “alpha” is added to the register POINT at step F9. When both the notes do not coincide with each other, that is when a key other than the key indicated by the note is played, a value of “alpha” is subtracted from the register POINT at step F10. After the addition or the subtraction of “alpha” has been carried out, an evaluation flag HYOKAF is set to “1” at step F11 and the procedure returns to the main procedure shown in FIG. 2A.

When the keyboard 6 is changed form “on” to “off”, that is, when any key of the keyboard 6 is released, the note corresponding to the releasd key is stored on the register KEY at step F12, and a note-off command is produced based on the note of the register KEY at step F13.

The note-off command is sent to the sound source 9 at step F14 and the flag KEY ONF is reset to “0” at step F15. The procedure is suspended and returns to the main procedure shown in FIG. 2A.

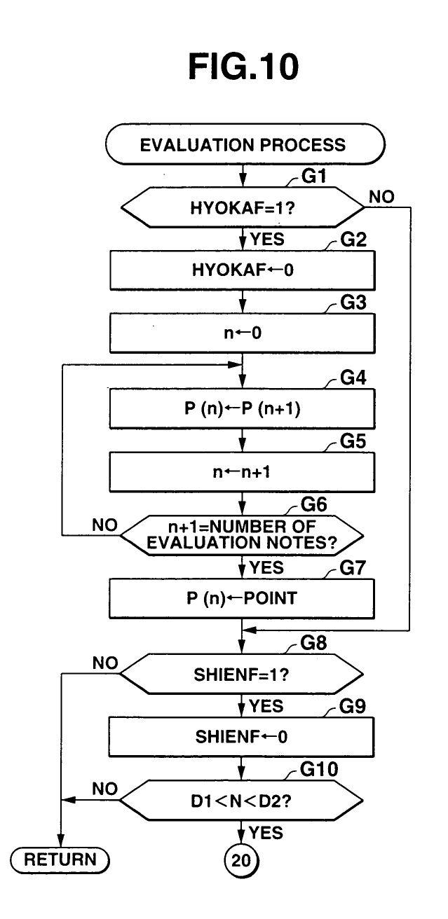

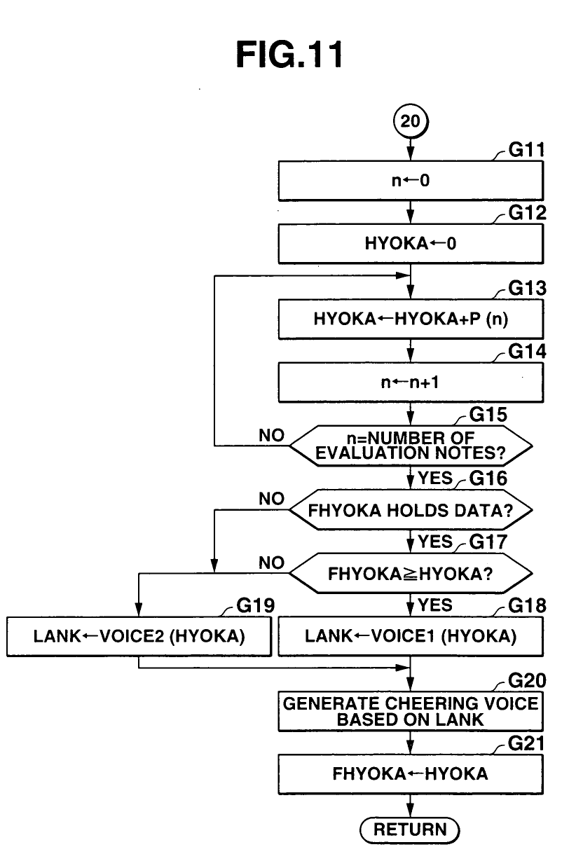

A flow char of the evaluation process at step A5 in the main flow chart shown in FIG. 2A is shown in FIGS. 10 and 11. At first, at step G1 in the flow chart shown in FIG. 10 it is judged whether the flag HYOKAF holds “1”. When the flag HYOKAF holds “1”, then this flag HYOKAF is reset to “0”. Then, a pointer “n” which designates an alignment P(n) during the time period for evaluation is set to “0” at step G3 and P (n+1) is substituted for P(n) at step G4, and the value of n is incremented at step G5. It is judged at step G6 whether or not a value of n+1 has reached an evaluation note number. When the value of n+1 has not reached the evaluation note number, the procedure returns to step G4 and the processes at step G4 through step G6 are repeatedly performed.

When it is determined at step G6 that the value n+1 has reached the evaluation note number, a value of the register POINT is stored in P(n) at step G7. After the value of the register POINT has been stored in P(n), it is judged at step G8 whether or not a flag SHIENF holds “1”. When the flag SHIENF holds “0”, the procedure is terminated. When the flag SHIENF holds “1”, this flag is reset to “0” at step G9.

It is judged at step G10 whether or not there are N pieces of notes of the music piece, the number N which is previously stored on the register N, during a time period (evaluation time period) except a time period during which the first note through D1-th note counted from the beginning appear and a time period during which D2-th note counted from the last through the last note appear, where the numbers D1 and D2 are previously set. When there are not N pieces of notes during the evaluation period, the procedure is terminated.

When there are N pieces of notes during the evaluation time period (which is defined by D1-th note and D2-th note), the pointer “n” of the alignment P(n) for designating the number of notes to be evaluated is set to “0” at step G11. Further, an evaluation register HYOKA is cleared to “0” at step G12 and a value of the alignment P(n) is added to the evaluation register HYOKA at step G13. A value of “n” is incremented at step G14, and it is judged at step G15 whether or not the value of “n” has reached the number of notes for evaluation. When the value of “n” has not yet reached the number of notes for evaluation, the procedure returns to step G13 and the processes at step G13 through step G15 are repeatedly performed.

When the value of “n” has reached the number of notes for evaluation, it is judged at step G16 whether or not evaluation data for the previous evaluation period has been held on a register FHYOKA. When the evaluation data has been held on the register FHYOKA, it is judged at step G17 whether or not a value of the register HYOKA which stores evaluation data for the present evaluation period is less than a value of the register FHYOKA, or whether or not the value of the register HYOKA is more than the value of the register FHYOKA. In other words, it is judged whether the evaluation for the present evaluation period is better, same or worse than the previous evaluation period.

When the value of the register HYOKA (present evaluation) is less than the value of the register FHYOKA (previous evaluation), on a register LANK is stored at step G18 data of a variable VOICE 1 (HYOKA) designating a first cheering voice, for instance, “Cheer up!”. When the value of the register HYOKA (present evaluation) is more than the value of the register FHYOKA (previous evaluation), or when the register FHYOKA holds no evaluation data, on the register LANK is stored at step G19 data of a variable VOICE 2 (HYOKA) designating a second cheering voice, for instance, “That's the way to go!”. After either of the above data has been stored on the register LANK, cheering voice data is output based on the data stored on the register LANK at step G20. Then, the register FHYOKA is renewed with the value of the register HYOKA at step G21, and waits for the next evaluation, and then the procedure is terminated and returns to the main procedure shown in FIG. 2A.

FIG. 12 is a view showing a graph illustrating relationship between evaluation measures and evaluation levels, where the number D1 is set to 25 and D2 is set to 8 with respect to a music piece for evaluation. As illustrated in the graph, the evaluation period is a time period except a time period from the beginning of the music piece to 25^{th} note counted from the beginning and a time period from 8^{th} note counted from the last to the last note as indicated by a heavy-line arrow. In other words, the evaluation period is a time period which contains a remained number of notes, the number of which is obtained by subtracting 25 (notes) and 8 (notes) from total number of notes of the music piece. A reference number of notes for evaluation is set to 10, and a performance of every reference number of notes (every 10 notes) is evaluated and scored, and a cheering voice is generated every 20 notes performance. The evaluation of the current 10 notes performance is compared with the evaluation of the previous 10 notes performance.

Each time when the first twentieth, thirtieth, fortieth, fiftieth, sixtieth, seventieth, eightieth, ninetieth and hundredth notes have been played, the performance of the prior 20 notes is evaluated and scored. Depending the evaluation and score the cheering supports are displayed on the display unit 8 and the cheering voices and sounds are generated. When the evaluation of performance with respect to first 10 notes and the following 10 notes is more than the evaluation of the prior 10 notes, the evaluation of performance of 20 notes is considered “Evaluation Up”, and on the contrary, when the evaluation of performance with respect to first 10 notes and the following 10 notes is less than the evaluation of the prior 10 notes, the evaluation of performance of 20 notes is considered “Evaluation Down”.

FIG. 13 is a view illustrating a relation in timing between a performance instruction of a guide note and an actual performance of the note. The example 1 indicates that a note C3 key has been played while the guide indication keeps on or during a time period from the time when a guide note C3 is turned on and to the time when the guide note C3 is turned off. The performance in the example 1 is evaluated “Point Up” and the evaluation process corresponds to the process (where a value of “alpha” is added to POINT) at step F9 in the flowchart of FIG. 9.

The example 2 indicates that the guide note C3 is turned on (the guide indication is turned on), while the note C3 key is held. The performance in the example 2 is also evaluated “Point Up” and the evaluation process corresponds to the process (where a value of “alpha” is added to POINT) at step E21 in the flowchart of FIG. 7.

The example 3 indicates that a note E3 key is played during a time period from the time when the guide note C3 is turned on and to the time when the guide note C3 is turned off. In other words, the example 3 shows the case where a key is played that is other than the key with the guide indication turned on. The performance in the example 3 is evaluated “Point Down” and the evaluation process corresponds to the process (where a value of “alpha” is subtracted from POINT) at step F10 in the flowchart of FIG. 9.

As described above, CPU 1 in the first embodiment sets the evaluation period (indicated in FIG. 12) depending on contents of the music piece for performance evaluation, and evaluates performance of every reference number of notes included in the music data during the evaluation period, and displays the evaluation results on the display unit 8. Since inappropriate time periods are excluded from the evaluation period, the user's technique can be evaluated correctly and it is expected that improvements to the user's technique will be made efficiently. Further, CPU 1 evaluates performance of every predetermined number of notes included in the music data and provides the user with detailed evaluation results. The performance evaluation apparatus according to the present embodiment advantages in efficiently improving the user's performance technique.

Since CPU 1 evaluates the performance (the value of the register HYOKA) for the current evaluation period by comparing with the performance (the value of the register FHYOKA) for the previous evaluation period, the user's incentive or concentration to enhance his/her technique may be judged objectively. Therefore, and appropriate pep supports may be provided to the user in real time.

When evaluating performance during the evaluation period set in accordance with the music data of the evaluation music, CPU 1 detects a state (non-performance state) in which a note to be played during the evaluation period is not actually played. Since supports relating to the evaluation results and the non-performance state are output through the sound source 9, the sound generating circuit 10 and the display unit 8, the user is released from tension while the user is giving performance of the evaluation music, and is allowed to avoid missing key manipulation. The usage of the performance evaluation apparatus will help the user to improve his/her playing technique efficiently.

Since CPU 1 detects a non-performance state in which all the reference number of notes (10 notes) are not played, it can be detected without failure the state in which the user gets too nervous to play the key. When the reference number of notes is set to 20 notes or 30 notes, and when the user plays only 2 or 3 notes, it may be considered that the user is in a too nervous state to play the key. Therefore, the performance evaluation apparatus may be modified to detect the state in which even the predetermined minimum number of notes included in the music data are not played as the non-performance state.

CPU 1 reads out music data or reference-performance data stored on the music memory 5, and detects a reference on-period from the read out music data, and further detects a real on-period from actual-performance data supplied from the keyboard 6. Further in the performance evaluation apparatus, when it is determined that the reference on-period and the real on-period are overlapped each other and that the corresponding scales are the same, then an evaluation point is added to the performance-evaluation score, and on the other hand when it is determined that the reference on-period and the real on-period are overlapped each other but the corresponding scales are not the same, then the evaluation point is subtracted from the performance-evaluation score. Therefore, there is no need to detect a timing difference in performance between the reference performance and the actual performance, or to perform a process such as a process of reading out the reference-performance data in advance, as effected in a conventional apparatus, resulting in releasing CPU 1 from a heavy processing work. Further, the evaluation point is added or subtracted from the performance-evaluation score, only when the user plays the instrument. Therefore, the user's performance is directly evaluated.

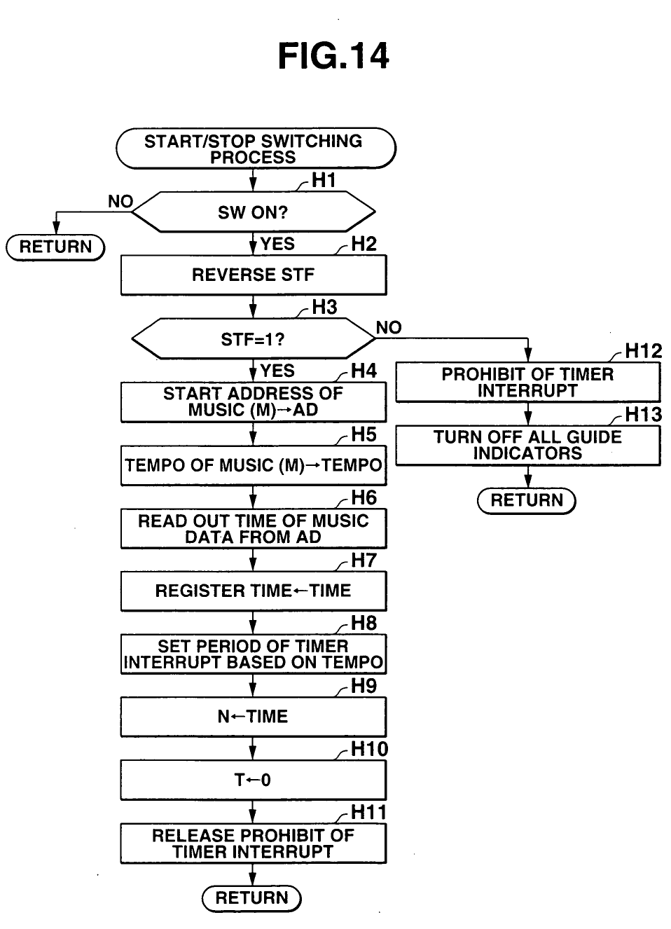

An operation of the performance evaluation apparatus according to the second embodiment of the invention will be described with reference to flow charts of operations performed by CPU 1 shown in FIG. 14 through FIG. 16. In the second embodiment, the main procedure shown in FIG. 2A, the timer interrupt process of FIG. 2B, the switching-process of FIG. 3, the music selecting process of FIG. 4, the keyboard process of FIG. 9, and the evaluation process of FIGS. 10 and 11, and a part of the automatic-performance process are performed in the same manner as in the first embodiment. Therefore, the different processes from the first embodiment will be described referring to the description and drawings of the first embodiment.

FIG. 14 is a flow chart of the start/stop switch process performed at step B3 in the switching-process shown in FIG. 3. It is judged at step H1 whether or not the start/stop switch is on or closed. When the switch is not on, then the procedure of FIG. 14 is suspended, but when the switch is on, the value of the start flag STF is reversed at step H2. It is judged at step H3 whether or not the start flag STF holds “1”. When the start flag STF holds “1”, CPU 1 starts the automatic performance and stores on the register AD the start address of the music piece (M) designated by the music number stored on the register (M) at step H4. Further, CPU 1 stores a tempo of the music piece (M) on the tempo register TEMPO at step H5.

A time of the music data at the start address designated by the register AD is read out at step H6 and stored on the register TIME at step H7. A time period of the timer interrupt based on the tempo of the register TEMPO at step H8. A time lapsed as the music piece is played is counted and stored on the register N, at step H9 and the register T is cleared to “0” at step H10, which register T counts the number of notes during a predetermined time period for evaluating the performance. Then, the prohibit by the timer interrupt is released at step H11.

When the start flag STF is reversed form “1” to “0” at step H3, the automatic performance is terminated and the timer interrupt is prohibited at step H12 and further all the guide indicators of the keyboard 6 are turned off at step H13. The procedure returns to the maim procedure shown in FIG. 2A.

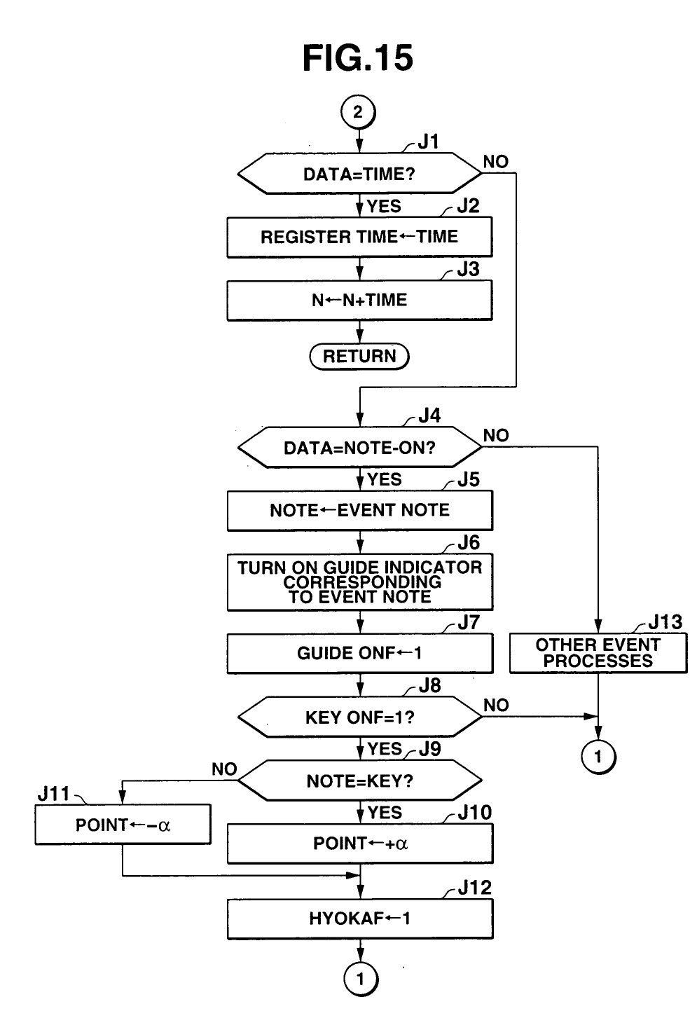

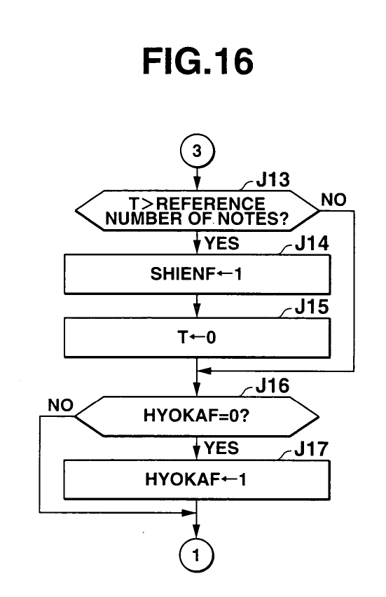

A flow chart of a part of the automatic-performance process at step A3 in the main flow chart of FIG. 2A is shown in FIGS. 15 and 16. The remaining part is the same as shown in FIG. 6 in the first embodiment. When the music data read out in the procedure of FIG. 6 is not END nor note-off, it is judged at step J1 (FIG. 15) whether or not the read out data represents a time. When the data represents a time, the time is stored on the register TIME at step J2 and the time is accumulated on the value of the register N at step J3. In the second embodiment, since the register N stores a time lapsed from the beginning of the music piece, time from an event to other event is accumulated on the value of the register N. Then, the procedure according to the flow chart shown in FIG. 15 is terminated.

When the read out data does not represent a time, it is judged at step J4 whether or not the data represents a note-on event. When the data represents a note-on event, a note of the event is stored on the register NOTE at step J5, and the guide indicator corresponding to the note of the event is turned on at step J6. Further, the guide flag GUIDE ONF is set to “1” at J7. At the following step J8 it is judged whether or not the flag KEY ONF indicating whether any key is played holds “1” (a played key).

When the flag KEY ONF holds “1”, it is judged at step J9 whether or not the note of the event stored on the register NOTE coincides with the note corresponding to the played key stored on the register KEY. When both the notes coincide with each other, that is, in case a key instructed to be played has been played, when the flag GUIDE FLAG is set to “1”, a value of “alpha” is added to a value of the register POINT at step J10. When the note of the event stored on the register NOTE and the note corresponding to the played key which is stored on the register KEY in the keyboard process shown in FIG. 9 do not coincide with each other, a value of “alpha” is subtracted from the value of the register POINT at step J11. After the addition or subtraction of the value of “alpha” has been carried out, the evaluation flag HYOKAF is set to “1” at step J12. When it is determined at step J4 that the data does not represent note on event, other event process is carried out at step J13. In case the flag KEY ONF holds “0” after the flag HYOKAF has been set to “1” at step J12, or after other event process has been carried out at step J13, the procedure advances to step E3 where the address stored on the register AD is incremented.

After the value of the register T has been incremented at step E9 (FIG. 6), it is judged at step J13 (FIG. 16) whether or not the number of notes stored on the register T has reached the number of the reference notes. When the number of notes of the register T has reached the reference number of notes, the flag SHIENF indicating whether or not supports should be given to the user is set to “1” (supports) at step J14, and the number of notes on the register T is cleared to “0” at step J15. After the register T is cleared, or when it is determined at step J13 that the number of notes stored on the register T has not reached the reference number of notes, it is judged at step J16 whether or not the flag HYOKAF holds “0”. When the flag HYOKAF holds “0”, then the flag HYOKAF is set to “1” at step J17. After the flag HYOKAF has been set to “1” or holds “1”, the procedure advances to step E3 (FIG. 6), where the register AD is incremented.

As described above, CPU 1 in the second embodiment evaluates performance of every predetermined number of notes included in the music data and provides the user with detailed evaluation results. The performance evaluation apparatus according to the present embodiment advantages in efficiently improving the user's performance technique.

Since CPU 1 detects the non-performance state in which no key is played during a predetermined period of music data, it can be detected without failure in the same manner as in the first embodiment the state in which the user gets too nervous to play the key. In case a longer evaluation period is set, even when the user has played only 2 or 3 notes, it may be considered that the user is in a too nervous state to play the key. Therefore, the performance evaluation apparatus may be modified so as to determine that the non-performance state is detected, when up to the minimum number of notes have not been not played by the user in a predetermined period of the music data.

An operation of the performance evaluation apparatus according to the third embodiment of the invention will be described with reference to the flow charts and the drawings. In the third embodiment, the main procedure shown in FIG. 2A, the timer interrupt process of FIG. 2B, the switching-process of FIG. 3, the music selecting process of FIG. 4, the keyboard process of FIG. 9, a part of the automatic-performance process, and a part of the evaluation process are carried out in the same as in the first embodiment. Therefore, the different processes from the first embodiment will be described referring to the description and drawings of the first embodiment.

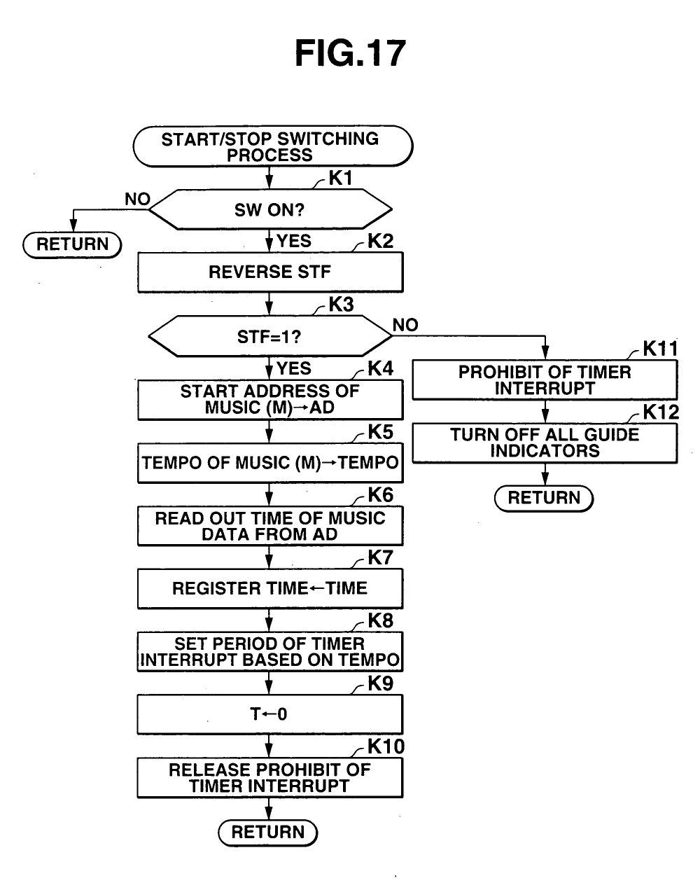

FIG. 17 is a flow chart of the start/stop switch process performed at step B3 in the switching-process shown in FIG. 3. It is judged at step K1 whether or not the start/stop switch is on or closed. When the switch is not on, then the procedure of FIG. 17 is suspended, but when the switch is on, the value of the start flag STF is reversed at step K2. It is judged at step K3 whether or not the start flag STF holds “1”. When the start flag STF holds “1”, CPU 1 starts the automatic performance and stores on the register AD the start address of the music piece (M) designated by the music number stored on the register (M) at step K4. Further, CPU 1 stores a tempo of the music piece (M) on the tempo register TEMPO at step K5.

A time of the music data at the start address designated by the register AD is read out at step K6 and stored on the register TIME at step K7. A time period of the timer interrupt based on the tempo of the register TEMPO at step K8. Then, the register T is cleared to “0” at step K9, which register T counts the number of notes during a predetermined time period for evaluating the performance, and the prohibit by the timer interrupt is released at step K10. The procedure returns to the main procedure of FIG. 2A.

When the start flag STF is reversed form “1” to “0” at step K3, the automatic performance is terminated and the timer interrupt is prohibited at step K11 and further all the guide indicators of the keyboard 6 are turned off at step K12. The procedure returns to the maim procedure shown in FIG. 2A.

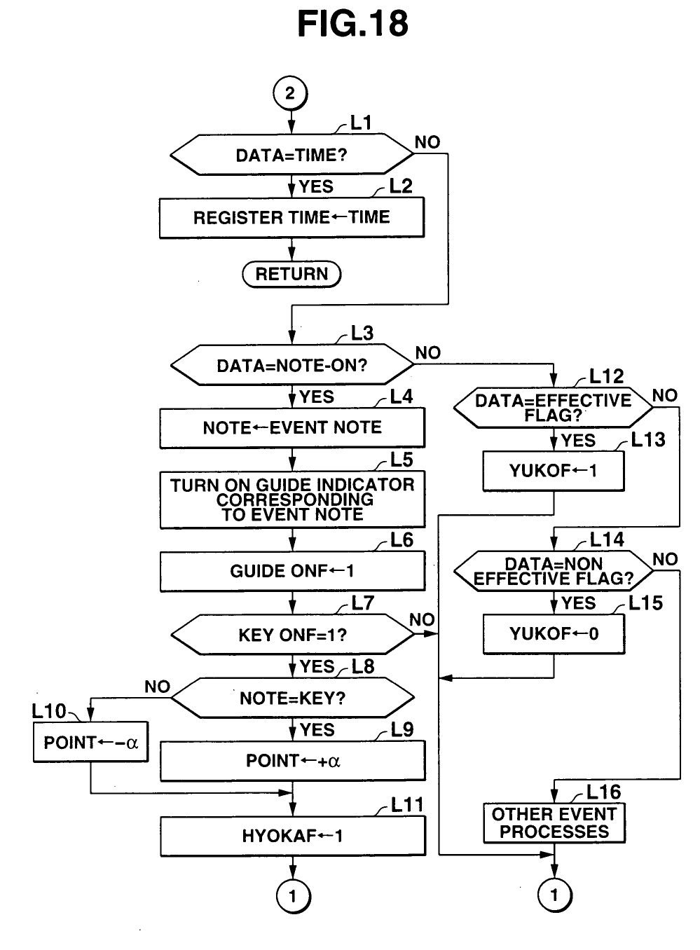

FIG. 18 is a flow chart of a part of the automatic-performance process at step A3 in the main flow chart of FIG. 2A. The remaining part is the same as shown in FIG. 6 in the first embodiment and as shown in FIG. 16 in the second embodiment. When the music data read out in the procedure of FIG. 6 is not END nor note-off, it is judged at step L1 (FIG. 18) whether or not the read out data represents a time. When the data represents a time, the time is stored on the register TIME at step L2 and the procedure is terminated.

When the read out data does not represent a time, it is judged at step L3 whether or not the data represents a note-on event. When the data represents a note-on event, a note of the event is stored on the register NOTE at step L4, and the guide indicator corresponding to the note of the event is turned on at step L5. Further, the guide flag GUIDE ONF is set to “l” at L6. At the following step L7 it is judged whether or not the flag KEY ONF indicating whether any key is played holds “1” (a played key).

When the flag KEY ONF holds “1”, a key of the keyboard 6 has been played. It is judged at step L8 whether or not the note of the event stored on the register NOTE coincides with the note corresponding to the played key stored on the register KEY in the keyboard process. When both the notes coincide with each other, that is, in case a key instructed to be played has been played, when the flag GUIDE FLAG is set to “1”, a value of “alpha” is added to a value of the register POINT at step L9. When the note of the event stored on the register NOTE and the note corresponding to the played key which is stored on the register KEY in the keyboard process shown in FIG. 9 do not coincide with each other, a value of “alpha” is subtracted from the value of the register POINT at step L10. After the addition or subtraction of the value of “alpha” has been carried out, the evaluation flag HYOKAF is set to “1” at step L11.

When it is determined at step L3 that the data does not represent a note-on event, it is judged at step L12 whether or not the data is an effective flag. When the data is the effective flag, a flag YUKOF is set to “1” at step L12. When the data is not the effective flag, it is judged at step L14 whether or not the data is a non-effective flag. When the data is a non-effective flag, the flag YUKOF is reset to “0” at step L15. When the data is not the effective flag and not non-effective flag, other event process is carried out at step L16.

In case the flag KEY ONF holds “0” at step L7 after the flag HYOKAF has been set to “1” at step L11, the flag YUKOF is set to “1” or “0” at steps L13 or L15, or other event process is carried out at step L16. Thereafter, the procedure advances to step E3 where the address stored on the register AD is incremented. After the value of the register T has been incremented at step E9 of FIG. 6, the procedure is performed in accordance with the flow chart shown in FIG. 16 in the second embodiment.

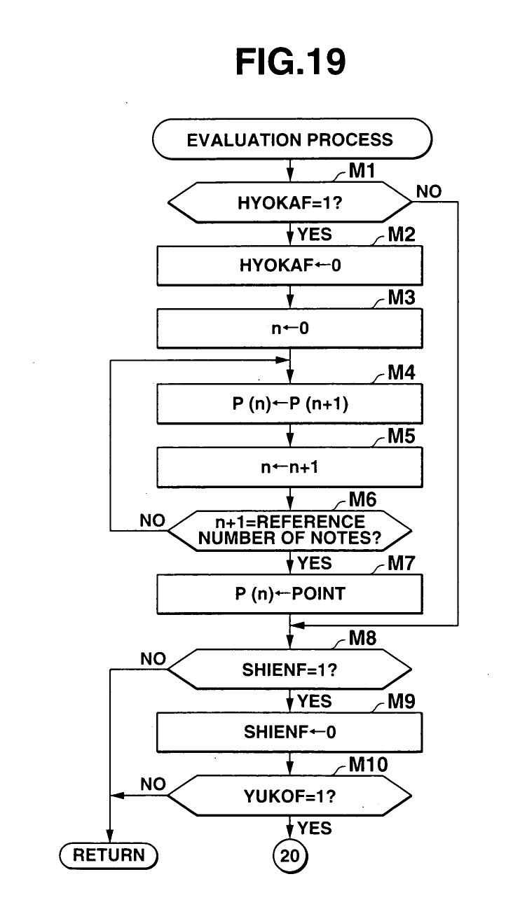

FIG. 19 is a flow chart of a part of the evaluation process at step A5 in the main flow chart of FIG. 2A. It is judged at step M1 (FIG. 19) whether the flag HYOKAF holds “1” or not. When the flag HYOKAF holds “1”, this flag is reset to “0” at step M2. The pointer “n” for specifying the alignment P(n) of the evaluation period is set to “0” at step M3. The alignment P(n) is substituted with P(n+1) at step M4 to increment the value of “n” at step M5. Then, it is judged at step M6 whether or not the value of “n+1” has reached the reference number of notes. When the value of “n+1” has not yet reached the reference number of notes, the procedure returns to step M4 and processes at Step M4 through step M6 are repeatedly performed.

When it is determined at step M6 that the value of “n+1” has reached the reference number of notes, the value of the register POINT is stored in P(n) at step M7. After the value of the register POINT has been stored in P(n), it is judged at step M8 whether or not a flag SHIENF holds “1” and when the flag SHIENF holds “0”, then the procedure is suspended. When the flag SHIENF holds “1”, this flag is reset at step M9. At step M10, it is judged whether or not the flag YUKOF holds “1”, and when the flag YUKOF holds “0”, then the procedure is suspended. When the flag YUKOF holds “1”, and a position in the music data under performance for evaluation is within the evaluation period (or an evaluation-support range), the process returns to the performance evaluation process (FIG. 11) in the first embodiment.

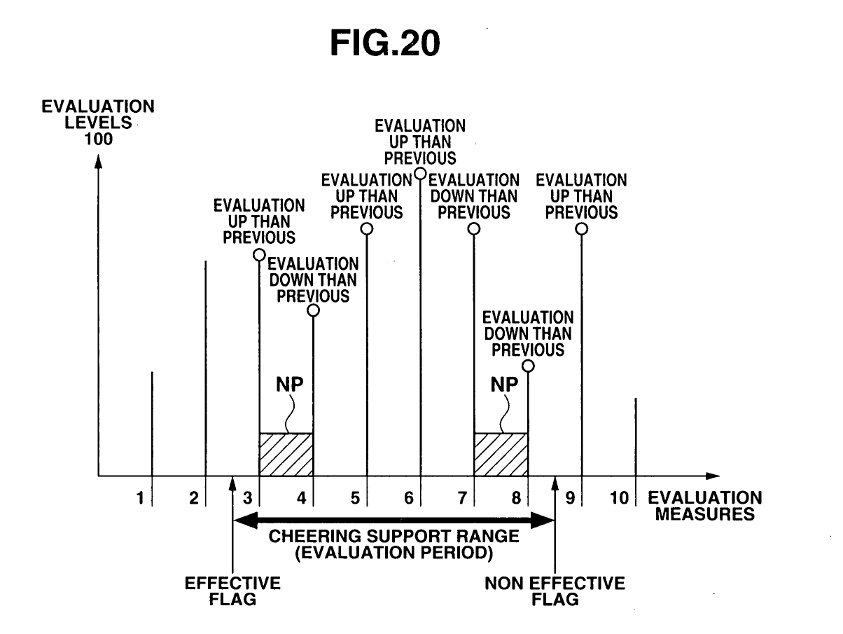

FIG. 20 is a graph showing an example of evaluation measures versus evaluation levels. The music data of the music piece for performance evaluation contains data of the effective flag and data of the non-effective flag. A time period between the effective flag and the non-effective flag is set as the evaluation period (or the evaluation-support range).

When all ten notes or all the reference number of notes are not played during a period from the effective flag to the non-effective flag, the this period is detected as non-performance state, or when no note is played during a predetermined period within the period from the effective flag to the non-effective flag, this predetermined period is detected as the non-performance state. More specifically, when all the ten notes are not played during a measure between “3” and “4” and a measure between “7” and “8” in FIG. 20, these periods are detected as the non-performance periods NP, respectively. Since it is determined that the user is in a too nervous state to play the note, cheering voices such as “Let's play” and/or “Take it easy” are generated to cheer up or cool down the user.

In the third embodiment set forth above, CPU 1 evaluates performance in every predetermined period (every reference number of notes) within the evaluation period set based on the effective flag and the non-effective flag both contained in the music data, and displays the results of the evaluation on the display unit 8. By setting the positions of the effective flag and the non-effective flag to exclude a period which is not appropriate for performance evaluation, from the evaluation period depending on the contents (difficulty level) of the music piece for evaluation, the user can evaluate and improve his/her technique of the performance effectively with use of the performance evaluation apparatus.

Further in the third embodiment, since CPU 1 detects the non-performance state in which no key is played during a predetermined period (a predetermined number of notes or a period within the predetermined period) within the evaluation period defined based on the effective flag and the non-effective flag, it can be detected without failure the state in which the user gets too nervous to play the key, in the same manner as in the first embodiment. In case a longer evaluation period is set, when only 2 or 3 notes are played by the user, it may be considered that the user is in a too nervous state to play the key. Therefore, the performance evaluation apparatus may be modified so as to determine that the non-performance state is detected, when up to the minimum number of notes have not been not played by the user in the evaluation period.

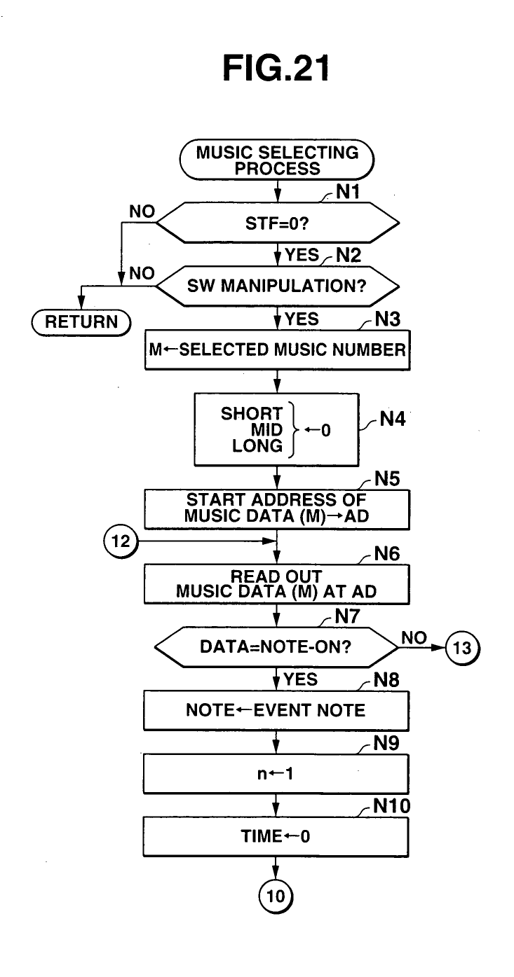

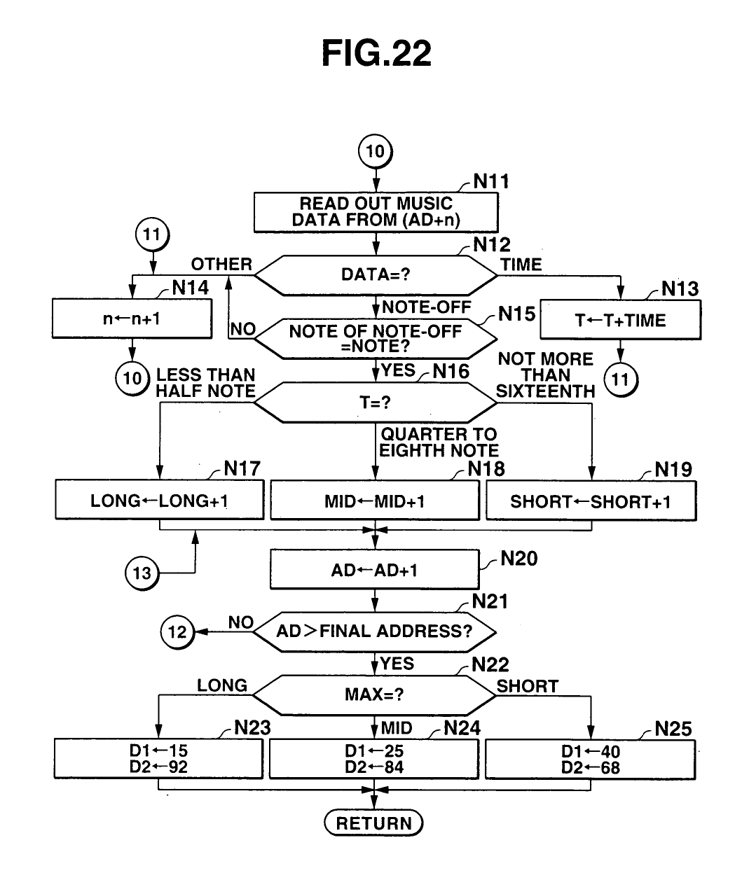

An operation of the fourth embodiment will be described with reference to FIG. 21 and FIG. 22. In the fourth embodiment, the music selecting process is different from the first through third embodiments.

In FIG. 21 it is judged at step N1 whether the flag STF holds “0” or not. When the flag STF holds “0” or the automatic performance is in a halt state, it is judged at step N2 whether the music selecting switch is manipulated or not. When the music selecting switch is not manipulated, or the flag STF holds “0” and the automatic performance is being carried out, the procedure is suspended and returns to the main procedure.

When it is determined at step N2 that the music selecting switch has been manipulated, a selected music number is stored on the register M at step N3. Then, a value of “0” is set to three registers SHORT, MID, LONG to clear same at step N4. Then, a start address of the music data (M) is stored on the resister AD at step N5, and the music data is read out from the address of the register AD at step N6 to judge the read out music data. It is judged at step N7 whether the read out data represents the note-on event or not. When the data represents the note-on event, the notes of the event are stored on the register NOTE at step N8.

A pointer “n” for reading out the music data is set to “1” at step N9, and the register TIME is cleared to “0” at step N10. At step N11 (FIG. 22), the music data is read out from the address of (AD+n), which is obtained by adding a value of “n” to the current address. At step N12, it is judged, of what type the read out data is. When the read out data represents a time, the time is accumulated on the register T at step N13. When the read out data is data other than time data or note-off data, the value of “n” is incremented at step N14, the procedure returns to step N11, where the following music data is read out, and a time data and a note-off event are searched through the read out music data.

When the data is note-off data, it is judged at step N15 whether or not a note of the note-off data coincides with the note stored on the register NOTE. When the note of the note-off data does not coincide with the note stored on the register NOTE, the value of “n”is incremented and the procedure advances to step N11, where the following music data is read out. A note-off event which coincides with a time and the note of the register NOTE is searched for through the music data. In other words, a time period (a sound length, or a note length) during which the note-on event stored on the register NOTE becomes a note-off event is measured.

When the note of the note-off data coincides with the note stored on the register NOTE, in other words, when a note length of the read out note-on note is stored, it is judged at step N16 whether or not the note length of the note stored on the register T is longer than a half note, falls within the range between a quarter note and an eighth note, or less than a sixteenth note.

When the note length of the note stored on the register T is longer than a half note, a value of the register LONG is incremented at step N17. When the note length of the note of the register T falls within the range between a quarter note and an eighth note, a value of the register MID is incremented at step N18. When the note length of the note of the register T is less than a sixteenth note, a value of the register SHORT is incremented at step N19. After the value of either of the register has been incremented, or when it is determined at step N21 (FIG. 21) that the data is not note-on data, the address of the register AD is incremented at step N20.

Then, it is judged at step N22 whether or not the address stored on the register AD exceeds the last address of the music data. When the address stored on the register AD has not yet exceeded the last address of the music data, the procedure returns to step N6 (FIG. 21), where the music data is read out from the address of the register AD. When the final address is stored on the register AD, it is judged at step N21 on which registers SHORT, MID and LONG the maximum number of notes is stored.

When the register LONG stores the maximum number of notes, registers D1 and D2 defining the evaluation period (evaluation-support range) are set to values “15” and “92” respectively at step N23. When the register MID stores the maximum number of notes, registers D1 and D2 are set to values “25” and “84” respectively at step N24. When the register SHORT stores the maximum number of notes, registers D1 and D2 are set to values “40” and “68” respectively at step N25. After registers D1 and D2 has been set to some values respectively, the procedure is suspended and returns to the main procedure. That is, the more the music data includes notes of a long sound length, the longer the evaluation period is set.

In the fourth embodiment described above, CPU 1 sets the evaluation period depending on the tendency of sounding lengths (or time periods from the note-on to the note-off) of notes contained in the music data. With respect to a music piece which contains more notes of a shorter note length (less beats are given), or a music piece which requires the performer to play the notes more frequently within a certain duration, a longer period is excluded from the evaluation period, allowing the user to play the music piece under no tension. On the contrary, relating a music piece which contains more notes of a longer note length (more beats are given), or a music piece which requires the performer to play the notes less frequently within a certain period, a shorter period is excluded from the period for evaluation or a longer evaluation period is set. Since the evaluation period is set to a proper length for performance evaluation, as set forth above, the user's performance technique is evaluated correctly, allowing the user to improve his/her performance technique more effectively.

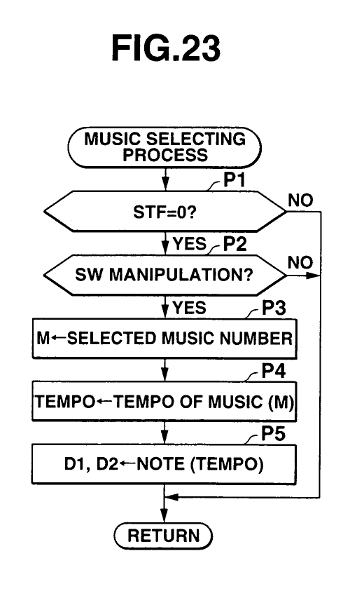

An operation of the fifth embodiment will be described with reference to FIG. 23. In the fifth embodiment, the music selecting process is different from the first through third embodiments.

In the flow chart of FIG. 23, it is judged at step P1 whether the flag STF holds “0” or not. When the flag STF holds “0” or the automatic performance is in a halt state, it is judged at step P2 whether the music selecting switch is manipulated or not. When the music selecting switch is not manipulated, or the flag STF holds “0” and the automatic performance is being carried out, the procedure is suspended and returns to the main procedure.

When it is determined at step P2 that the music selecting switch has been manipulated, the music number of the selected music piece is stored on the register M at step P3. A tempo of the music piece (M) is stored on the register TEMPO at step P4. The notes of the register NOTE (TEMPO) are stored on the registers D1 and D2 defining the evaluation period (evaluation-support range) at step P5. The procedure is suspended and returns to the main procedure. The faster the tempo is, the larger values the registers D1 and D2 hold, setting a shorter evaluation period.

In the fifth embodiment described above, CPU 1 sets the evaluation period depending on the tempo of the music piece. With respect to music data of a fast tempo, a longer period is excluded from the evaluation music length allowing the user to play the notes in a relaxed state. On the contrary, relating a music piece of a low tempo, a shorter period is excluded from the evaluation music length or a longer evaluation period is set. Since the evaluation period is set to a proper length for performance evaluation, as set forth above, the user's performance technique is evaluated correctly, allowing the user to improve his/her performance technique more effectively.

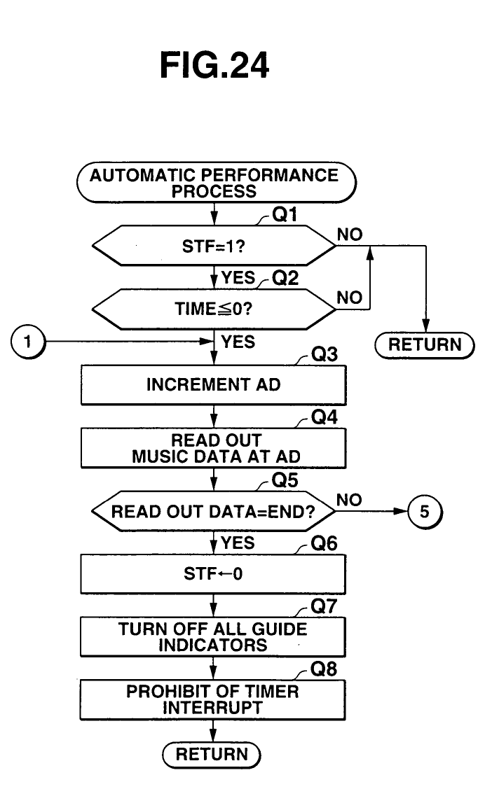

An operation of the sixth embodiment will be described with reference to FIG. 24 through FIG. 37. In the fifth embodiment, the main procedure (the performance evaluation procedure) shown in FIG. 2, the switching process of FIG. 3, the music selecting process of FIG. 4, the start/stop switching process of FIG. 5 are performed in the same way as described in other embodiments, and further description thereof is omitted.

A flow chart of the automatic performance process at step A3 in the main flow chart shown in FIG. 2A is shown in FIG. 24 through FIG. 29. It is judged at step Q1 whether the register holds “1” or not. When the register holds “1” and the automatic performance is being carried out, it is judged at step Q2 whether or not the register TIME, which is decremented every timer interrupt, reaches “0”. When the register STF holds “0”, or when the register TIME has not yet reached “0”, the procedure of FIG. 24 is suspended. When the register TIME has reached “0”, the register AD is incremented to read out the following music data at step Q3, and the music data at the address of the register AD is read out at step Q4.

It is judged at step Q5 whether or not the read out data represents END or the end of the music piece. When the read out data represents END, the register STF is reset to “0” at step Q6, and all the guide indicators are turned off at step Q7. Further, the timer interrupt is prohibited at step Q8, and the procedure of FIG. 24 is terminated and returns to the main procedure of FIG. 2A.

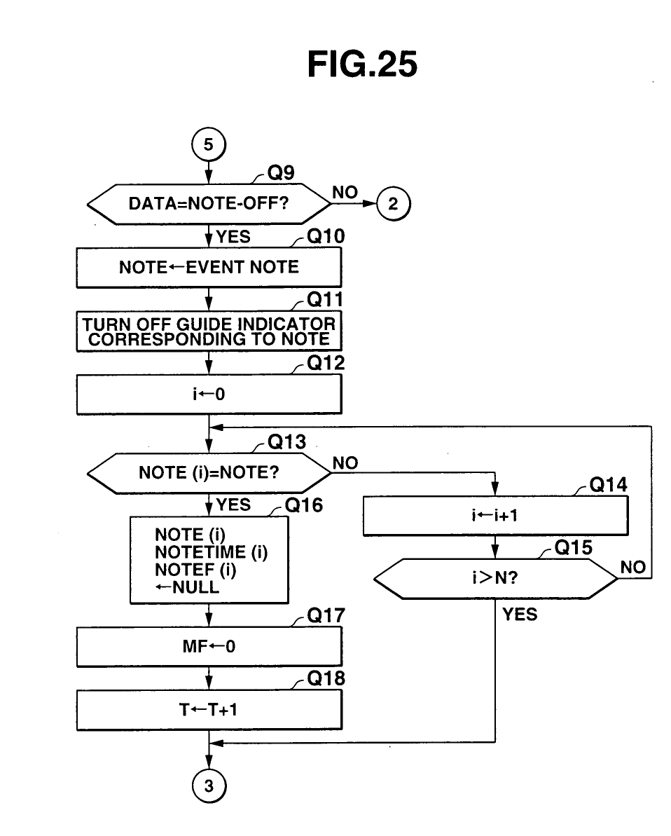

Meanwhile, when the read out data does not represent END, it is judged at step Q9 (FIG. 25) whether the data is a note-off event or not. When the data is a note-off event, event data is stored on the register NOTE at step Q10, and the guide indicator for the key corresponding to the data of the register NOTE at step Q11.

In a poly performance through up to N sounding channels of the sound source 9, an alignment register for performance guide indicators stores up to N pieces of notes, and the pointer “i” for designating the alignment register is set to the initial value of “0” at step Q12. While the pointer “i” is successively incremented, a note corresponding to the note-off event is searched for. In other words, it is judged at step Q13 whether or not a note of NOTE(i) coincides with a note of the register NOTE. When the note of NOTE(i) does not coincide with the note of the register NOTE, the value of the pointer “i” is incremented at step Q14, and further it is judged at step Q15 whether the pointer value “i” has exceeded the value of “N” or not. When the pointer value “i” does not exceed the value of “N”, it is judged at step Q13 whether or not a note of NOTE(i) coincides with the note of the register NOTE.

When it is determined at step Q13 that the note of NOTE(i) coincides with the note of the register NOTE, data of NULL indicative of an empty state is stored on a time register NOTETIME(i) and a flag NOTEF(i) at step Q16. The time register NOTETIME(i) is for storing an allowance time for waiting for playing a key, which is defined by a time duration between a time when the guide indicator is turned on or when an event starts sounding and a time when the user starts the performance after the guide indicator has been turned on. The flag NOTE(i) holds “1” while a note is played, and holds “NULL” while no sound is generated.

After data of NULL has been stored on NOTE(i), NOTETIME(i) and NOTEF(i), a flag MF is reset to “0” at step Q17. The flag MF is set to “1” while all N pieces of notes in the alignment register are sounding. Therefore, after data of NULL has been stored on the NOTE(i) at step Q16, the register MF is reset to “0”, because at least one of the alignment register is brought to an empty state. Since a process has finished with respect to one note in the evaluation period, the register T for counting the number of notes or the number of events is incremented at step Q18.

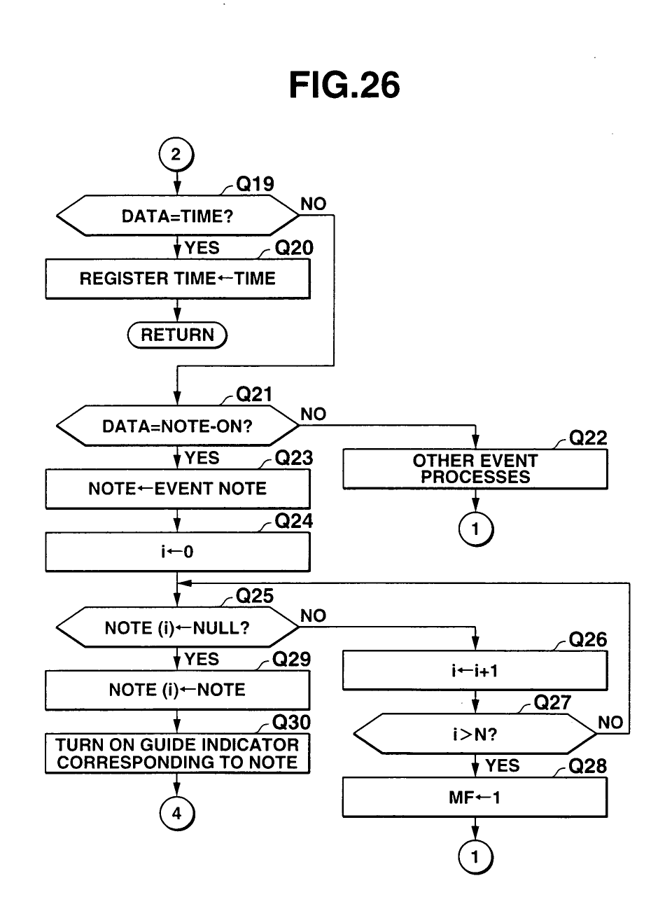

When it is determined at step Q9 that the data does not represent note-off, it is judged at step Q19 (FIG. 26) whether the data represents a time or not. When the data represents a time, the value of the time is stored on the register TIME at step Q20, and the procedure returns to the main procedure.

When the data does not represent a time, it is judged at step Q21 whether or not the data represents note-on. When it is determined that the data does not represent note-on, the other event process is performed at step Q22. The procedure returns to step Q3 (FIG. 24), where the register AD is incremented.

When it is determined at step Q21 (FIG. 26) that the data represents note-on, the note of the event is stored on the register NOTE at step Q23. In a poly performance through up to N sounding channels of the sound source 9, the alignment register for performance guide indicators stores up to N pieces of notes, and the pointer “i” for designating the alignment register is set to the initial value of “0” at step Q24. While the pointer “i” is successively incremented, an empty area is searched for to store the note-on event. In other words, it is judged at step Q25 whether NOTE(i) holds NULL data or not. When NOTE(i) does not hold NULL data, the value of the pointer “i” is incremented at step Q26, and further it is judged at step Q27 whether the pointer value “i” has exceeded the value of “N” or not. When the pointer value “i” has exceeded the value of “N”, or when no empty area had been found, the flag M is set to “1” at step Q28. In this case, the event of the register NOTE is of no effect and the procedure returns to step Q3, where the register AD is incremented.

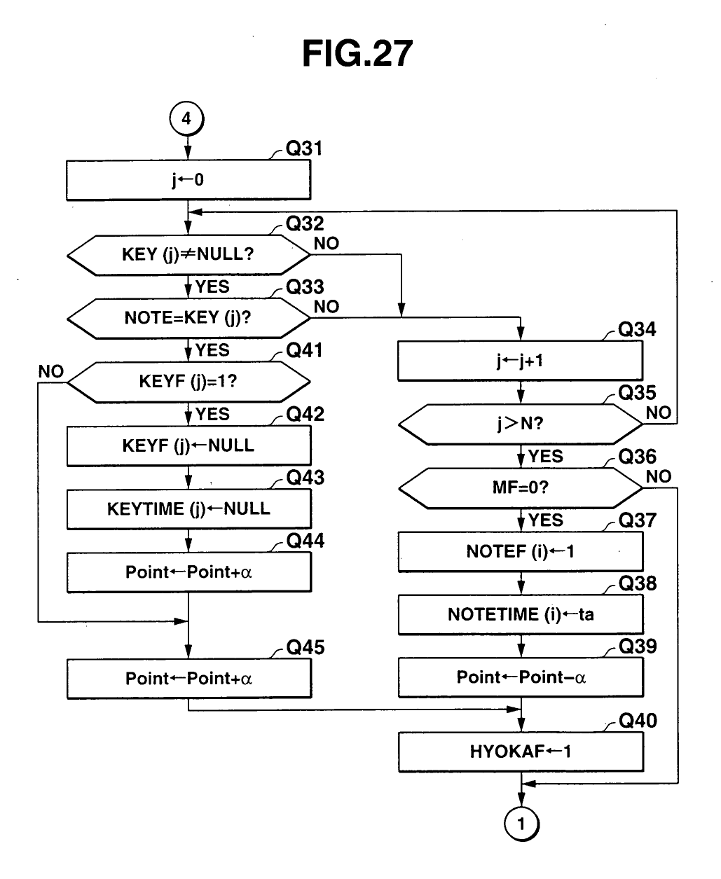

Meanwhile, when it is determined at step Q25 (FIG. 26) that NOTE(i) holds NULL data, the note of NOTE is stored on NOTE(i) at step Q29, and an guide indicator corresponding to NOTE is displayed at step Q30. After the guide indicator being displayed, a pointer “j” for designating an alignment register KEY is set to the initial value of “0” at step Q31 (FIG. 27). The alignment register KEY stores a note of the keyboard 6. While a value of the pointer “j” is incremented, an area corresponding to the note of the register NOTE is searched for through the alignment register KEY(j).

It is judged at step whether or not the alignment register KEY(i) does not hold NULL or is not in an empty state. When the alignment register KEY(i) does not hold NULL, it is judged at step Q33 whether or not a note of register NOTE coincides with a note of the alignment register KEY(i). When the alignment register KEY(i) holds NULL, or when a note of register NOTE does not coincide with a note of the alignment register KEY(i), the value of the pointer “j” is incremented at step Q34, and is judged at step Q35 whether the value of the pointer “j” has exceeded the maximum value N or not. When the value of the pointer “j” has exceeded the maximum value N, it is judged at step Q36 whether the flag MF holds “0” or not. In other words, when no note corresponding to the note of the register NOTE has not been found in the alignments registers KEY(0) through KEY (N), it is judged whether or not an empty area (the flag MF holds “0”) exists in the alignment registers KEY(0) through KEY(N).

When the flag MF holds “0” and an empty area exists in the alignment registers KEY(0) through KEY(N), a note-on event for guiding a key to be played is of effect, and it is indicated that there is no note corresponding to the note of the register NOTE at the time. In this case, the flag NOTEF(i) is set to “1” at step Q37, the allowance time “ta” for waiting for playing the key is stored on the register NOTETIME(i) at step Q38. Since no note corresponding to the note of the register NOTE has been found in the alignment registers KEY(0) through KEY (N), a value of “alpha” is subtracted from the value of the Point for counting the evaluation score at step G39, and the evaluation flag HYOKAF is set to “1” (evaluation) at step Q40.

When it is determined at step Q35 that the value of the pointer “j” has not yet exceeded the value of “N”, and at step Q32 that KEY(j) does not hold NULL, it is judged at step Q33 whether or not there is a note of KEY(j) which coincides with the note of the register NOTE. When the note of KEY(j) coincides with the note of the register NOTE, it is judged at step Q41 whether a flag KEYF (j) indicating whether the note of KEY(j) is held or released has been set to “1” (key held) or NULL (key released). When the flag KEYF holds “1”, the flag KEYF(J) is set to NULL at step Q42.

Further, a time register KEYTIME(j) is set to NULL at step Q43. The time register KEYTIME(j) stores an allowance time for waiting for the guide indicator, which is defined by a time duration between a time when a performance starts and a time when the note-on event starts sounding. Then, the value of “alpha” is added to the evaluation score Point at step Q44. When the note is played, which note corresponds to the guide indicator corresponding to the note of the register NOTE, and a guide indication instruction to play a key is given in the allowance time for waiting for an instruction, the flag KEYF(j) holds “1”. Therefore, the value of “alpha” is added to the Point at Q44 to compensate the Point from which the value of “alpha” is subtracted at step Q39. When the note of the register NOTE coincides with the note of the alignment KEY(j), the value of “alpha” is added to the POINTER at step Q45, and the flag HYOKAF is set to “1” at step Q40.

Meanwhile, when the flag KEYF(j) holds “0” at step Q41, or when a key corresponding to the note of the register NOTE is played at the time of sounding, the value of “alpha” is added to the POINTER at step Q45, and the flag HYOKAF is set to “1” at step Q40.

After the flag HYOKAF has been set to “1”, or when it is determined at step Q36 that the flag MF holds “1”, the procedure returns to step Q3, where the address register AD is incremented.

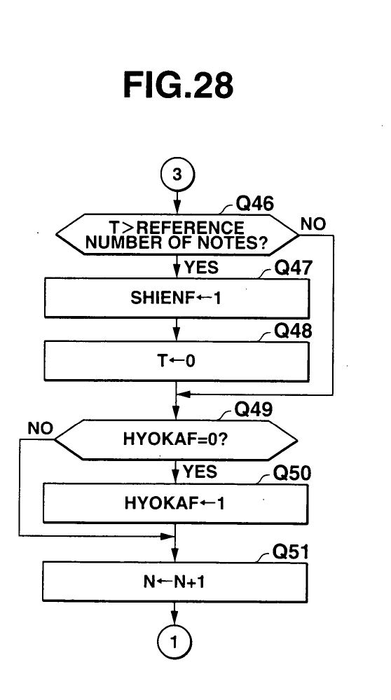

When the value of “T” is incremented at Q18 (FIG. 25), or when it is determined at step Q15 (FIG. 25) that the pointer “i” designating the alignment register for performance guide has exceeded the maximum value “N”, it is judged at step Q46 (FIG. 28) whether the number of notes which have been played has exceeded the reference number of notes. When the number of notes of the register T has reached the reference number of notes, the flag SHIENF, which indicates whether or not visual and/or cheering supports should be given is set to “1” (supports) at step Q47, and the number of notes of the register T is cleared to “0” at step Q48. After the register T being cleared, or when it is determined at step Q46 that the number of notes of the register T has not yet reached the reference number of notes, it is judged at step Q49 whether the flag HYOKAF holds “0” or not. When the flag HYOKAF holds “0”, the flag HYOKAF is set to “1” at step Q50. After the flag HYOKAF has been set to “1”, or when the flag HYOKAF holds “1”, the number of notes stored on the register N, which stores the number of notes of the music piece from the very beginning is incremented At step Q51, and the procedure returns to step Q3 (FIG. 2A), where the address of the register AD is incremented.

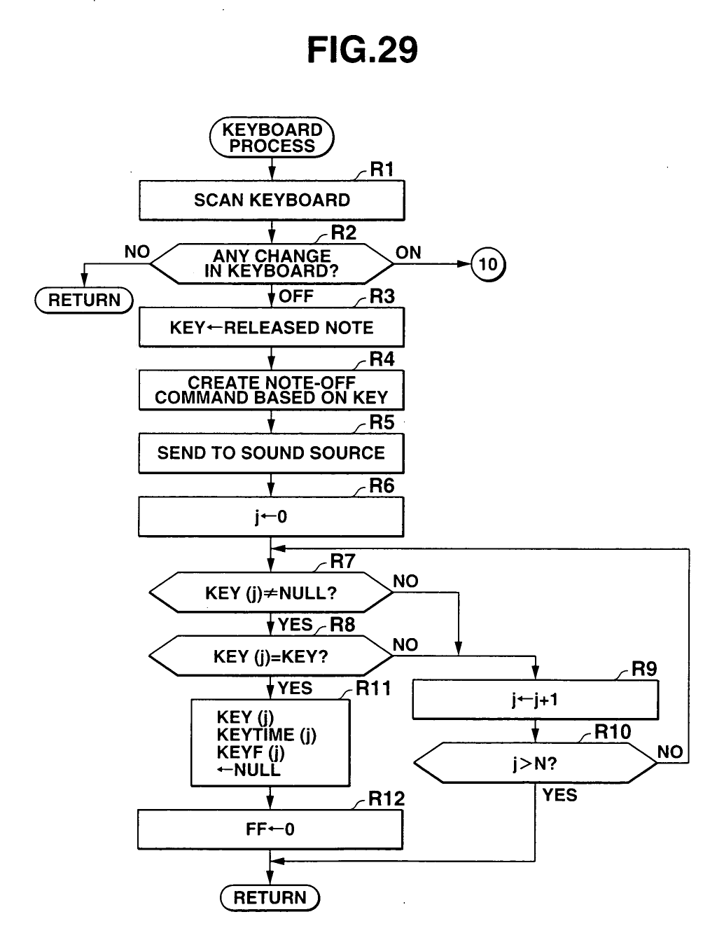

A flow chart of the keyboard process at step A4 in the main flow chart of FIG. 2A is shown in FIG. 29 through FIG. 31. At step R1 in FIG. 29, the keys of the keyboard 6 are scanned to detect at step R2 whether any key is played or any key is released. When no change in keyboard is detected, the procedure is suspended and returns to the main procedure (FIG. 2A). When the change in keyboard changes from ON to OFF, or when any key of the keyboard is released, the note of the released key is stored on the register KEY at step R3, and a note-on command is created based on the note of the register KEY at step R4, and the note-on command is sent to the sound source 9 at step R5.

Then, the pointer “j” designating the alignment register of key change is set to the initial value of “0” at step R6. While the value of the pointer “j” is successively incremented, an area for the note of the released key is searched. That is, it is judged at step R7 whether or not the register KEY(j) does not holds NULL. When the register KEY(j) does not hold NULL, or when the register KEY (j) is not in an empty state, it is judged at step R8 whether the note of the register KEY (j) coincides with the note of KEY or not. When the register KEY (j) holds NULL (the register KEY (j) is in an empty state), or when the note of the register KEY (j) does not coincide with the note of KEY, the value of the pointer “j” is incremented at step R9. Then, it is judged at step R10 whether or not the value of the pointer “j” has exceeded the maximum value N. When the value of the pointer “j” has not exceeded the maximum value N, and further when it is determined at step R7 that KEY (j) is not in NULL, it is judged at step R8 whether the note of the register KEY(j) coincides with the note of KEY.

When the note of the register KEY (j) coincides with the note of KEY, the registers KEY (j), KEYTIME (j) and KEYF (j) are set to NULL at step R11, and a flag FF is set to “0” (in an empty state) at step R12, which flag FF indicates that the alignment register of key change is not in an empty state or is in an empty state. Thereafter, when it is determined at step R10 that the value of the pointer “j” has exceeded the maximum value N, the procedure returns to the main procedure (FIG. 2A)

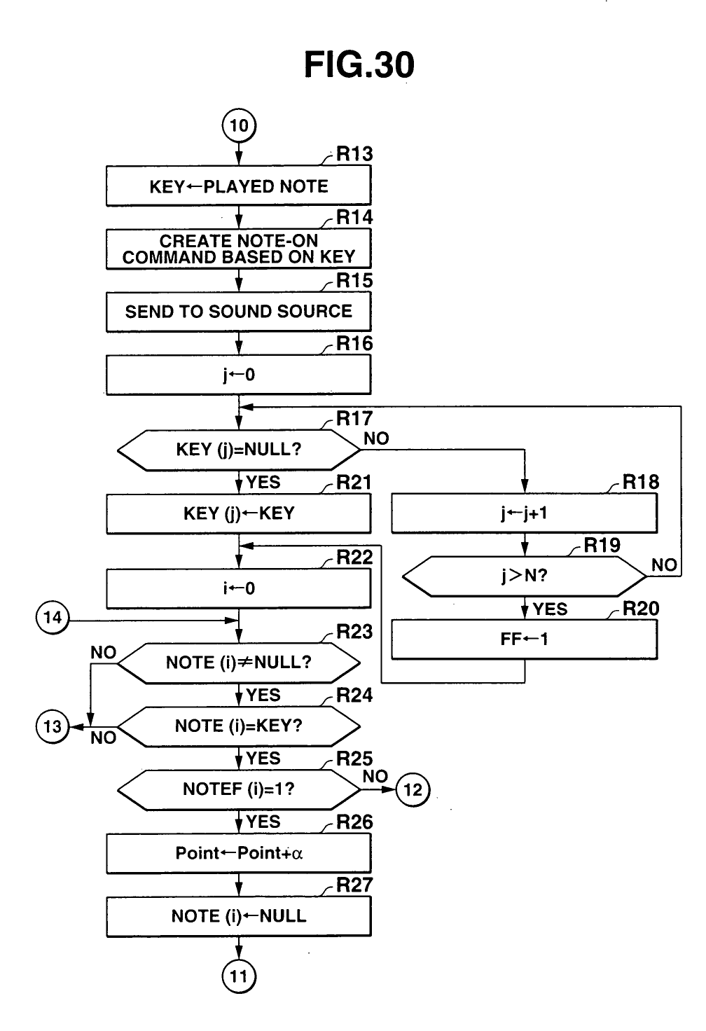

When it is determined at step R2 that the change in the keys of the keyboard 6 changes from OFF to ON, or that either of the keys of the keyboard is played, the note of the played key is stored on the register KEY at step R13 (FIG. 30). A note-on command is created based on the note of the register KEY at step R14, and sent to the sound source 9 at step R15. Then the pointer “j” designating the alignment register of key change is set to “0” at step R16, and an area is searched for to store the note of the played key.

It is judged at step R17 whether or not the register KEY(j) holds NULL. When the register KEY (j) does not hold NULL, the value of the pointer “j” is incremented at step R1, and it is judged at step R19 whether the value of the pointer “j” has exceeded the maximum value N. When the value of the pointer “j” has exceeded the maximum value N, the flag FF is set to “1” (no empty area) at step R20. When the value of the pointer “j” has not yet exceeded the maximum value N, it is judged at step R17 whether the register KEY(j) is in NULL or not.

When the register KEY(j) holds NULL, or when the flag FF holds “1”, the pointer “i” designating the performance guide alignment is set to the initial value “0” at step R22. While the pointer “i” is successively incremented, contents of the alignment register NOTE(i) are searched for. In other words, it is judged at step 23 whether or not the alignment register NOTE(i) does not hold NULL, and when the alignment NOTE(i) does not hold NULL, it is judged at step R24 whether or not the note of the alignment register NOTE(i) coincides with the note of KEY.

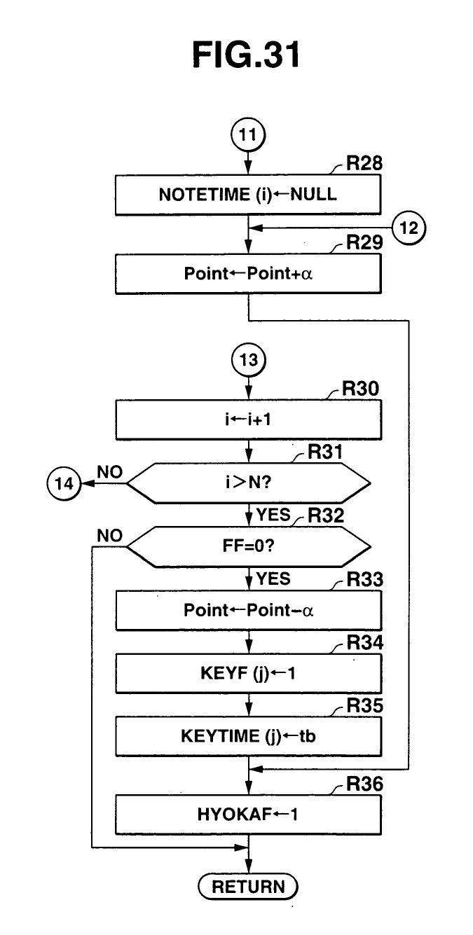

When the alignment NOTE(i) holds NULL, or when it is determined at step R24 that the note of the alignment register NOTE(i) does not coincide with the note of KEY, the value of the pointer “i” is incremented at step R30 (FIG. 31), and it is judged at step R31 whether the value of the pointer “i” has exceeded the maximum value N of the performance guide alignment. When the value of the pointer “i” has not yet exceeded the maximum value N of the performance guide alignment, it is judged at step R30 (FIG. 30) whether the alignment NOTE(i) holds NULL or not.

When it is determined at step R31 that the value of the pointer “i” has exceeded the maximum value N of the performance guide alignment, it is judged at step R32 whether the flag FF holds “0” (an empty area available). When the flag FF holds “1”, the alignment register of key change has no empty area, and then the procedure returns to the main procedure. Meanwhile, when the flag FF holds “0”, the note of the played key is of effect, and is not guided to be played. In this case, the value of “alpha” is subtracted from the Point at step R33, and KEY(j) is set to “1” at step R34, and further the allowance time “tb” for waiting an instruction is stored on KEYTIME(j) at step R35. Then the flag HYOKAF is set to “1” (evaluation) at step R36.

When it is determined at step R24 (FIG. 30) that the note of NOTE)i) coincides with the note of KEY, it is judged at step R25 whether the flag NOTEF(i) holds “1” or not. When the flag NOTEF(i) holds “1”, or when a key which is indicted to be played, is played within the allowance time “ta” for waiting for an instruction, a value of “alpha” is added to the evaluation score register Point at step R26. The evaluation score register Point, from which “alpha” is subtracted at step R33 (FIG. 31) is compensated with the added “alpha”.

Then, NOTE(i) is set to NULL at step R27, and NOTETIME(i) is set to NULL at step R28 (FIG. 31). At step R29, the value of “alpha” is added to the evaluation score register Point. In other words, when a key corresponding to a note, which the user is instructed to play, is played, a point is added to the evaluation score. Then the flag HYOKAF is set to “1” (evaluation) at step R36.

When it is determined at step R25 (FIG. 30) that NOTE(i) holds NULL, since the note which the user is instructed or guided to play coincides with the played note, the value “alpha” is added to the evaluation score register Point at step R29 (FIG. 31). Then, HYOKAF is set to “1” (evaluation) at step R36 and the procedure returns to the main procedure.

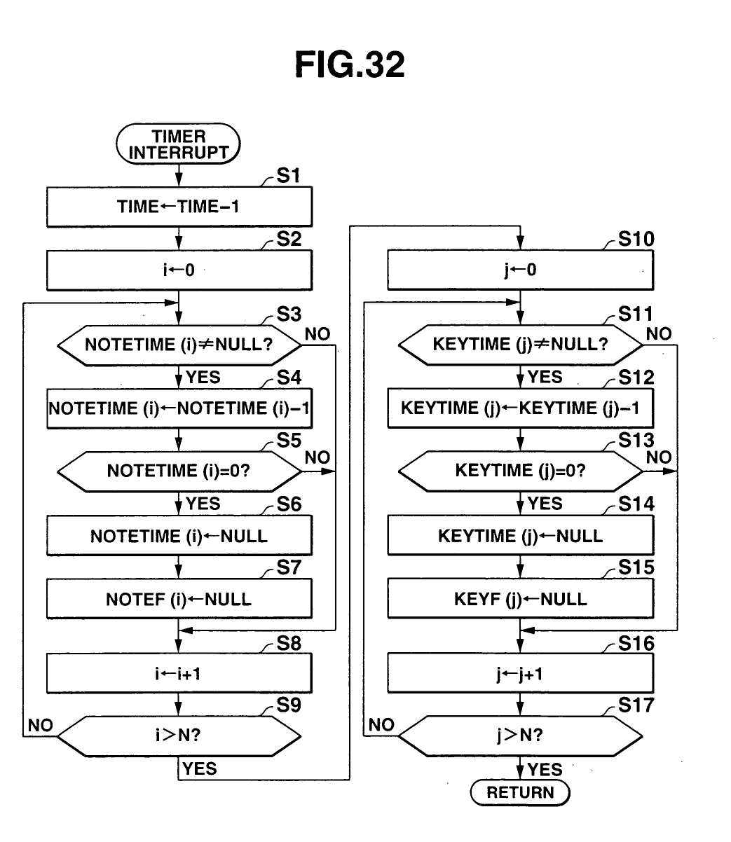

FIG. 32 is a flow chart of the timer interrupt. The register TIME is decremented in response to a timer interrupt every a certain time period at step S1. Then, the pointer “i” designating the performance guide alignment register is set to the initial value “0” at step S2, and while the pointer “i” is successively incremented, the processes at step S3 through step S9 (a loop procedure) are repeatedly carried out.

In the loop procedure, it is judged at step S3 whether or not NOTETIME(i) does not hold NULL. When NOTETIME(i) does not hold NULL, the value of NOTETIME(i) (the initial value is “ta”) is decremented at step S4. Then, it is judged at step S4 whether the value of NOTETIME(i) has reached “0” or not. In other words, it is judged whether or not no key has been played even after the allowance time “ta” for waiting for playing the key has lapsed. When the value of NOTETIME (i) has reached “0”, NOTETIME(i) is set to NULL at step S6 and also NOTEF(i) is set to NULL at step S7. In this case, since a key is played to start the performance too late after the timing of sounding of the note-on event, a state for waiting for playing the key is cancelled.

After NOTEF(i) has been set to NULL at step S7, or when it is determined at step S5 that NOTETIME(i) holds NULL or when the value of NOTETIME(i) has not yet reached “0”, the value of the pointer “i” is incremented at step S8 and it is judged at step S9 whether the value of the pointer “i” has exceeded the maximum value N or not. When the value of the pointer “i” has not yet exceeded the value N, the procedure returns to step S3 and the loop procedure is repeatedly carried out. When it is determined at step S9 that the value of the pointer “i” has exceeded the value N, the loop procedure is suspended, the pointer “j” designating the alignment register of key change is set to the initial value “0” at step S10, and while the value of the pointer “j” is successively incremented, the loop procedure is repeatedly carried out at step S11 through step 17.

In the loop procedure, it is judged at step S11 whether KEYTIME(j) does not hold NULL or not, and when KEYTIME(j) does not hold NULL, the value of KEYTIME(j) (the initial value is “tb”) is decremented at step S12. It is judged at step S13 whether the value of KEYTIME(j) has reached “0” or not. In other words, it is judged whether or not an instruction or a guide indicating a key to be played is not given after the allowance time “tb” for waiting for the guide indicator has lapsed. When the value of KEYTIME(j) has reached “0”, KEYTIME(j) is set to NULL at step S14 and also KEYF(j) is set to NULL at step S15. In this case, since a key is played to start the performance too early before the timing of sounding of the note-on event, a state for waiting for the guide indicator is cancelled.

After KEYF(j) has been set to NULL at step S15, or when it is determined at step S11 that KEYTIME(j) is in NULL or when the value of KEYTIME(j) has not yet reached “0”, the value of the pointer “j” is incremented at step S16 and it is judged at step S17 whether the value of the pointer “j” has exceeded the maximum value N or not. When the value of the pointer “j” has not yet exceeded the value N, the procedure returns to step S11 and the loop procedure is repeatedly carried out. When the pointer “j” has exceeded the value N, the loop procedure is suspended, and the procedure returns to the main procedure.

The allowance time “ta” for waiting for playing the key and the allowance time “tb” for waiting the guide indicator may be changed in accordance with the user's setting. Further, the evaluation apparatus may be modified such that when a key is played during a time period between the note-on and the note-off, it is considered that the key is played in good timing and therefore a point is added to the evaluation score.

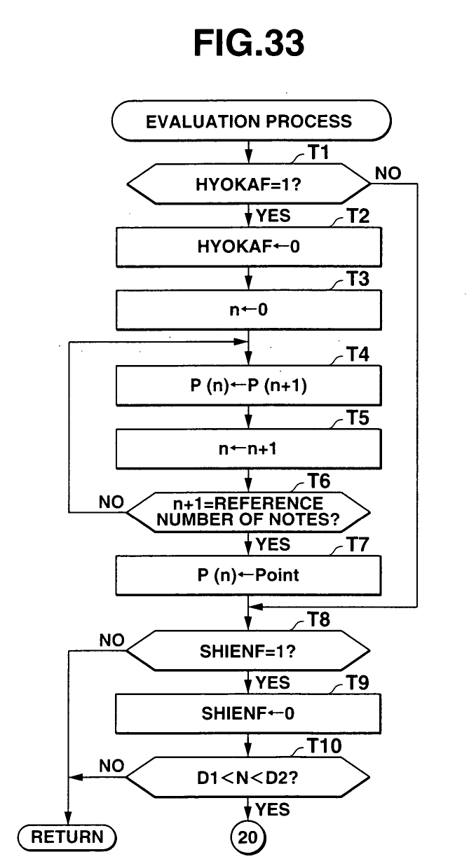

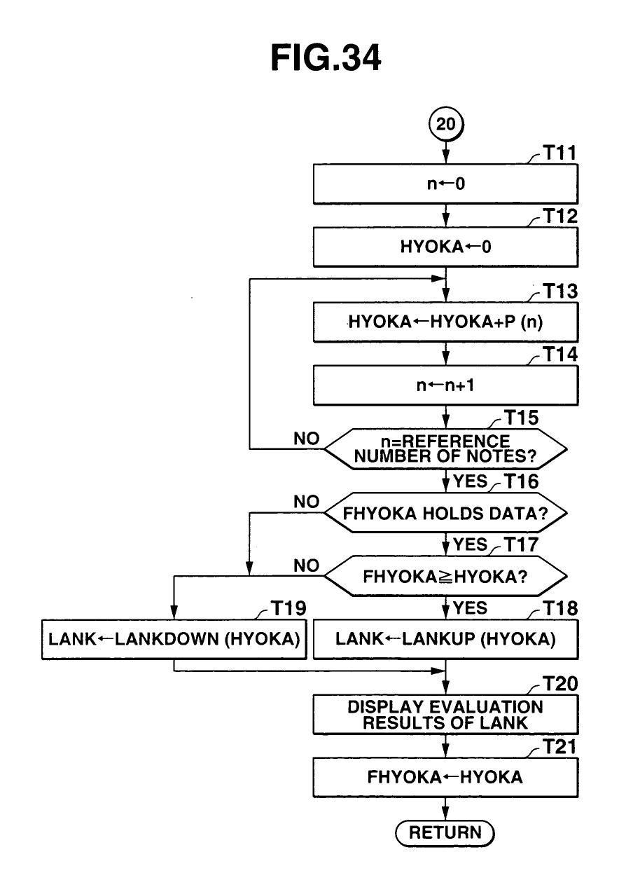

The detailed flow chart of the evaluation process at step A5 in the main procedure shown in FIG. 2A is shown in FIG. 33 and FIG. 34. It is judged at step T1 whether the flag HYOKAF holds “1” or not. When the flag HYOKAF holds “1”, this flag is reset to “0” at step T2. A pointer “n” designating the alignment register P (n) for the evaluation period is set to “0” at step T3, and P(n+1) is substituted for P(n) at step T4 to increment the value of the pointer “n” at step T5. Then, it is judged at step T6 whether the value of “n+1” has reached the reference number of notes. When the value of “n+1” has not yet reached the reference number of notes, the procedure returns to step T4, and the processes at step T4 through step T6 are repeatedly carried out.

When it is determined at step T6 that the value of “n+1” has reached the reference number of notes, the value of POINT is stored on P(n) at step T7. After the value of POINT has been stored on P(n), it is judged at step T8 whether the flag SHIENF holds “1” or not. When the flag SHIENF holds “0”, the procedure is suspended and when the flag SHIENF holds “1”, the SHIENF is reset at step T9.

It is judged at step T10 whether or not the number of notes counted from the beginning of the music piece stored on the register N falls within the range between the number of notes D1 and the number of notes D2. In other words, it is judged if there are N pieces of notes in a time period (evaluation period) excluding a time period from the beginning to D1-th note and a time period from D2-th note to the last. When there are not the numbers of notes stored on the register N in the evaluation period, the procedure is suspended.

When there are the number of notes stored on the register N in the evaluation period, the pointer “n” designating the alignment register P(n) or the number of evaluation notes is set to “0” at step T11. Then, the evaluation register HYOKA is cleared to “0” at step T12, and the value of P(n) is added to the evaluation register HYOKA at step T13. The value of the pointer “n” is incremented at step T14, and it is judged at step T15 if the value of the pointer “n” has reached the number of evaluation notes. When the value of the pointer “n” has not yet reached the number of evaluation notes, the procedure returns to step T13, and the processes at step T13 through step T15 are repeatedly carried out.

When the value of the pointer “n” has reached the number of evaluation notes, it is judged at step T16 whether the register FHYOKA for storing evaluation data in the previous evaluation period stores the evaluation data. When FHYOKA stores the evaluation data, it is judged at step T17 whether the value of HYOKA, which stores the evaluation data in the current evaluation period, is less than the value of FHYOKA, or the value of HYOKA is higher than the value of FHYOKA. In other words, it is judged if the evaluation for the current evaluation period is less than, or the same as, or higher than the previous evaluation.

When the evaluation for the current evaluation period is higher than the previous evaluation or when there is no evaluation data in FHYOKA, data of LANKUP (HYOKA) which is higher than the previous evaluation is stored on a register LANK at step T18. Meanwhile, when the evaluation for the current evaluation period is not higher than the previous evaluation, data of LANKDOWN (HYOKA) which is not higher than the previous evaluation is stored on the register LANK at step T19. After data has been stored on the register LANK, the evaluation result is displayed on the display unit 8 based on the data of the register LANK at step T20. Then, the value of HYOKA is stored on FHYOKA for the performance evaluation in the following evaluation period at step T21, and the procedure finishes and returns to the main procedure (FIG. 2A).

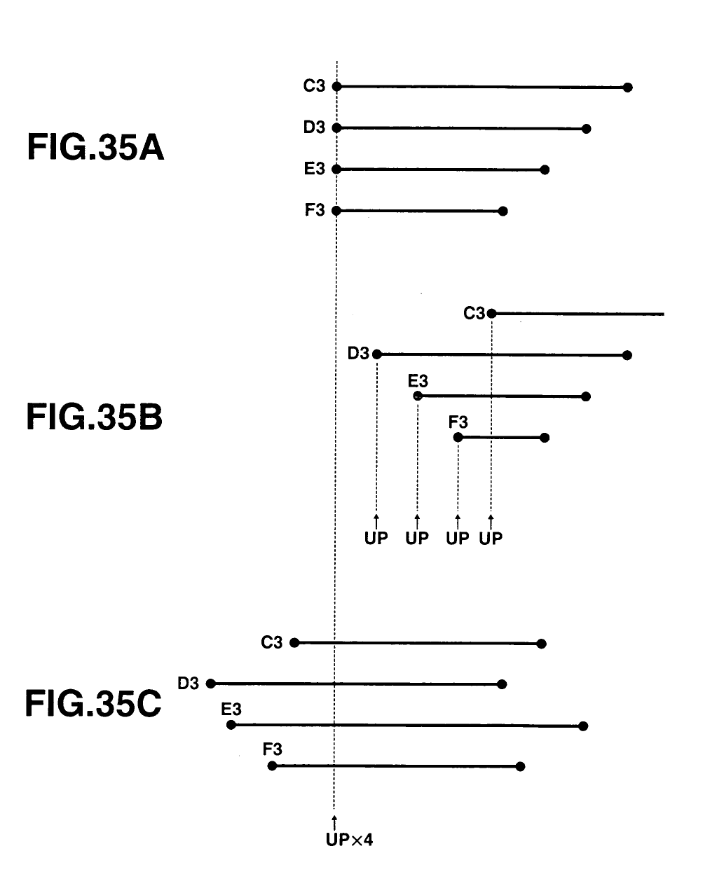

An operation of the performance evaluation apparatus according to the sixth embodiment will be described in detail with reference to views shown in FIG. 35 through FIG. 37. FIG. 35 is a view illustrating by way of example the played keys and performance guidance of a chord. FIG. 35(1) is illustrating a chord or a combination of four guide notes (C3, D3, E3 and F3) of the same timing for the initiation of sound generation and showing sounding periods of the four guide notes. FIG. 35(2) is illustrating by way of example the times at which four notes are played respectively after the timing for the initiation of sound generation. All of these notes are played within the sounding periods respectively, and therefore point-up processes (UP) are carried out with respect to the four notes respectively to add “alpha” to the Point. FIG. 35(3) is illustrating other example of the notes, all of which are played at the times before the timing for the initiation of sound generation, respectively. With respect to all the four notes, the point-up processes are carried out at the timing of sound generation of the guide notes to add “alpha” to the Point.

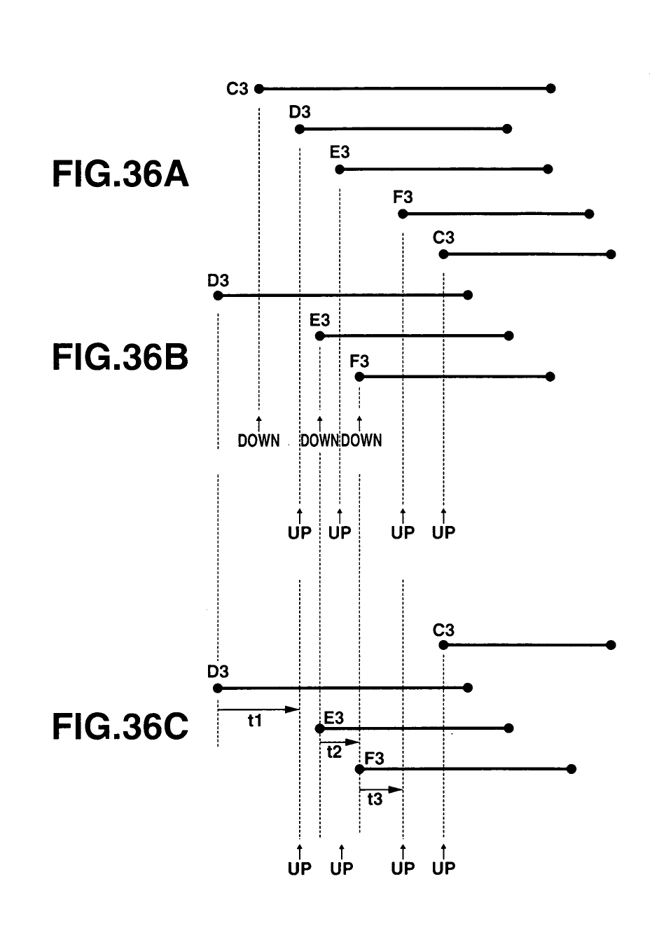

FIG. 36 is a view illustrating by way of example the played keys and performance guidance of plural notes each of a different timing for the initiation of sound generation. FIG. 36(1) is illustrating four guide notes of notes (C3, D3, E3 and F3) each of a different timing for the initiation of sound generation. FIG. 36(2) is illustrating the evaluation process performed when notes are played with no allowance time “tb” for waiting for the guide indicator. The note of D3 is played at the timing for the initiation of performance, and a guide is given at the timing for the initiation of sound generation of the note C3. In other words, it is determined that the guide note does not coincide with the played note, and a Point-Down process is performed to subtract “alpha” from the Point. Thereafter, when the guide is given at the timing for the initiation of sound generation of the note D3, a Point-Up process is performed to add “alpha” to the Point. When the note of E3 is played at the timing for the initiation of performance, guides have been given for the notes C3 and D3. Then, the Point-Down process is performed to subtract “alpha” from the Point. When the guide is given at the timing for the initiation of sound generation of the note E3, the Point-Up process is performed to add “alpha” to the Point. When the note of F3 is played at the timing for the initiation of performance, guides have been given for the notes C3, D3 and E3. Then, the Point-Down process is performed to subtract “alpha” from the Point. When the guide is given at the timing for the initiation of sound generation of the note F3, the Point-Up process is performed to add “alpha” to the Point.

A described above, when the allowance time “tb” for waiting the guide indicator is not considered, the Point-Down process is performed three times and the Point-Up process is performed for four times, resulting in adding “alpha” to the Point for one time. Even if a note is played a little before the timing for the initiation of sound generation of such note, a point is subtracted from the Point and thereafter a point is added to compensate the point subtracted from the Point. As the result, the user's performance technique is not evaluated correctly.

FIG. 36(3) is illustrating the evaluation process performed when notes are played with the allowance time “tb” for waiting for the guide indicator. When the note of D3 is played at the timing for the initiation of performance of such note D3 but no guide has been given for the note D3, the Point-Down process is not performed for the time period of “tb” and when the timing for the initiation of sound generation of the note D3 has been reached after a time “t1” (“t1”<“tb”) has lapsed, the Point-Up process is performed. Similarly, even when the note of E3 is played at the timing for the initiation of performance of such note E3 but no guide has been given for the note E3, the Point-Down process is not performed for the time period of “tb”, and when the timing for the initiation of sound generation of the note E3 has been reached after a time “t2” (“t2”<“tb”) has lapsed, the Point-Up process is performed. Further, when the note of F3 is played at the timing for the initiation of performance of such note F3 and even when no guide has been given for the note F3, the Point-Down process is not performed for the time period of “tb”, and when the timing for the initiation of sound generation of the note F3 has been reached after a time “t3” (“t3”<“tb”) has lapsed, the Point-Up process is performed.

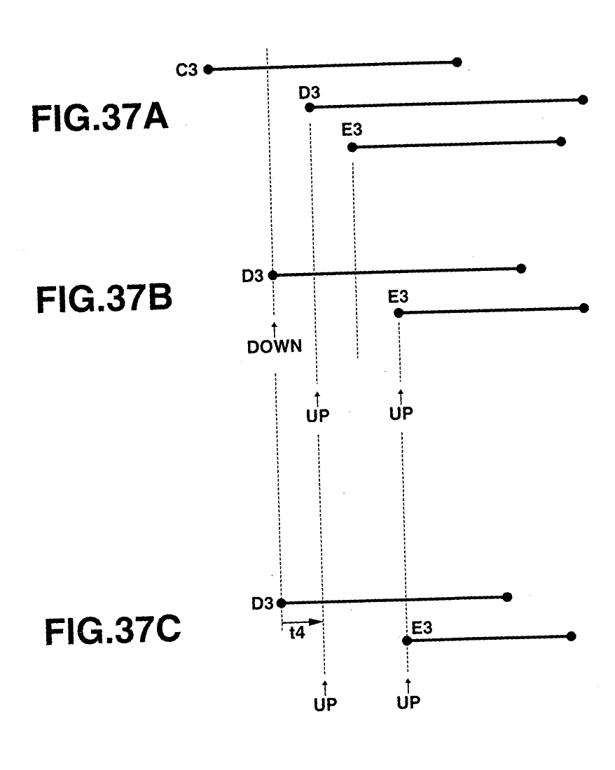

FIG. 37 is a view illustrating by way of example a case in which no key is played meanwhile there is given performance guidance of plural notes each of a different timing for the initiation of sound generation.

FIG. 37(1) is illustrating the guide note of three notes (c3, D3 and E3) each of a different timing for the initiation of sound generation. FIG. 37(2) is illustrating the evaluation process performed when notes are played with no allowance time “tb” for waiting for the guide indicator. At the time when the note D3 is played at the timing for the initiation for performance of such D3, a guide has been given for playing the note C3. Therefore, it is considered that the note D3 has been played in accordance with the guide note of note C3, and the Point-Down process is performed to subtract “alpha” from the Point. Thereafter, when the timing for the initiation of sound generation of the note D3 has been reached, the Point-Up process is performed to add “alpha” to the Point. As described above, in case that no allowance time “tb” for waiting for the guide indicator is prepared, even when the note is played a little before the timing for the initiation of sound generation has been reached, the Point-Down process is performed to balance against the added “alpha”. As the result the user's performance technique cannot be evaluated correctly.

FIG. 37(3) is illustrating the evaluation process performed when notes are played with the allowance time “tb” for waiting for the guide indicator. When the note D3 is played at the timing for the initiation of performance, and even when no guide for the note D3 has been given, the Point-Down process is not performed for the time of “tb”, and when the timing for the initiation of sound generation of the note D3 has been reached after the time period of “tb” has lapsed, the Point-Up process is performed to add “alpha” to the Point.

As described above, CPU 1 in the sixth embodiment designates a pitch of a sound event of the music data and a sounding period defined by the time period between the timing for the initiation of sound generation and the timing of sound vanishing, and detects the pitch of the played note and the timing of the initiation of performance. Further, CPU 1 judges whether the designated pitch coincides with the detected pitch or not. When detected the timing for the initiation of performance within the sounding period, or when designated the timing for the initiation of sound generation within a predetermined time period after the detected timing for the initiation of sound generation, CPU 1 determines that the timings coincide with each other or that the note is played at a good timing. When CPU 1 determines that the designated pitch coincides with the detected pitch and that the timings coincide with each other, a point is added to the evaluation score. On the contrary, CPU 1 determines that the designated pitch does not coincide with the detected pitch or that the timings do not coincide with each other, a point is subtracted from to the evaluation score.

As set forth above, the invention evaluates the user's performance of the evaluation music correctly, and will improve the user's performance technique efficiently.

In the embodiments set forth above, the performance evaluation apparatus is described, in which CPU 1 executes the performance evaluation program previously stored on the program ROM 3 shown in FIG. 1. A data processing apparatus such as a personal computer may provide the same and/or similar features set forth above, in which CPU 1 executes the performance evaluation program stored on an external storing medium such as a flexible disc, CD-ROM, and/or the performance evaluation program down loaded through the communication network such as the Internet. In this case, the performance evaluation program will comprise the invention.

What is claimed is:

1. A performance evaluation apparatus comprising:
a reference-performance data supplying unit for successively supplying reference-performance data, the reference-performance data prepared for designating a pitch of a musical sound for generating a sound, a time at which a sound of the musical sound should be generated and a time at which the sound of the musical sound should be vanished;
a actual-performance data supplying unit for successively supplying actual-performance data including a time of instructing to generate a sound of a musical sound at the designated pitch and a time of instructing to vanish the sound of the musical sound;
a reference on-period extracting unit for extracting a reference on-period indicative of a period between the time at which the sound of the musical sound should be generated and the time at which the sound of the musical sound should be vanished, based on the reference-performance data supplied from the reference-performance data supplying unit;
a real on-period extracting unit for extracting a real on-period indicative of a period between the time of instructing to generate the sound of the musical sound and the time of instructing to vanish the sound of the musical sound, based on the actual-performance data supplied from the actual-performance data supplying unit;
a judging unit for judging whether the reference on-period extracted by the reference on-period extracting unit and the real on-period extracted by the real on-period extracting unit overlap with each other or not;
a comparing unit for compare the pitch of the sound generated in the reference on-period extracted by the reference on-period extracting unit and the pitch of the sound generated in the real on-period extracted by the real on-period extracting unit, only when the judging unit determines that the reference on-period and the real on-period overlap with each other; and
an evaluation score calculating unit for adding an evaluation point to an evaluation score, when the comparing unit determines that both the pitches are the same and for subtracting the evaluation point from the evaluation score, when the comparing unit determines that both the pitches are not the same.

2. The performance evaluation apparatus according to claim 1, wherein the reference-performance data supplying unit comprises:
a performance-data memory for storing a series of data including on-event data instructing to initiate sound generation of the musical sound at the designated pitch, off-event data for instructing to vanish the sound of the musical sound, and a time period between the on-event and the off-event; and
a reading out unit for reading out and supplying event data corresponding to the time period from the performance-data memory.

3. A performance evaluation program comprising:
a step of successively supplying reference-performance data, the reference-performance data prepared for designating a pitch of a musical sound for generating a sound, a time at which a sound of the musical sound should be generated and a time at which the sound of the musical sound should be vanished;
a step of successively supplying actual-performance data including a time of instructing to generate a sound of a musical sound at the designated pitch and a time of instructing to vanish the sound of the musical sound;
a step of extracting a reference on-period indicative of a period between the time at which the sound of the musical sound should be generated and the time at which the sound of the musical sound should be vanished, based on the supplied reference-performance data;
a step of extracting a real on-period indicative of a time period between the time of instructing to generate the sound of the musical sound and the time of instructing to vanish the sound of the musical sound, based on the supplied actual-performance data;
a step of judging whether the extracted reference on-period and the extracted real on-period overlap with each other or not;
a step of comparing the pitch of the sound generated in the real on-period with the pitch of the sound generated in the reference on-period, only when it is determined that the reference on-period and the real on-period overlap with each other; and
a step of adding an evaluation point to an evaluation score, when it is determined that both the pitches are the same and subtracting the evaluation point from the evaluation score, when it is determined that both the pitches are not the same.

4. A performance evaluation apparatus including a display device comprising:
a period setting unit for setting an evaluation period in accordance with contents of music data to be performed;
a performance evaluation unit for evaluating performance of the music data in every predetermined period within the evaluation period set by the period setting unit; and
an evaluation outputting unit for displaying a result of evaluation made by the performance evaluation unit on the display device.

5. The performance evaluation apparatus according to claim 4, wherein the performance evaluation unit evaluates performance of the music data every predetermined number of notes.

6. The performance evaluation apparatus according to claim 4, wherein the performance evaluation unit evaluates performance of the music data every lapse of a predetermined time period.

7. The performance evaluation apparatus according to claim 4, wherein the period setting unit sets the evaluation period based on identification data contained in the music data.

8. The performance evaluation apparatus according to claim 4, wherein the period setting unit sets the evaluation period in accordance with the tendency of sound periods of sound events contained in the music data.

9. The performance evaluation apparatus according to claim 4, wherein the period setting unit sets the evaluation period in accordance with a tempo of the music data.

10. The performance evaluation apparatus according to claim 4, wherein the performance evaluation unit compares the performance in a current predetermined period with the performance in the previous predetermined period to evaluate the performance of the current predetermined period.

11. A performance evaluation program for executing a procedure, which comprises:
a first step of setting an evaluation period in accordance with contents of music data to be performed;
a second step of evaluating performance of the music data in every predetermined period within the evaluation period; and
a third step of displaying a result of evaluation made in the second step on a display device.

12. A performance supporting apparatus comprising:
a period setting unit for setting an evaluation period in accordance with contents of music data to be performed;
a performance evaluation unit for evaluating performance of the music data in the evaluation period set by the period setting unit;
a non-performance detecting unit for detecting a non-performance state during which non of notes to be played in the evaluation period is played; and
a support providing unit for providing support for the result of evaluation made by the performance evaluation unit and the non-performance state detected by the non-performance detecting unit.

13. The performance supporting apparatus according to claim 12, wherein the non-performance detecting unit determines that there is the non-performance state when a state is detected in which up to the minimum number of notes are not played among the predetermined number of notes to be played.

14. The performance supporting apparatus according to claim 12, wherein the non-performance detecting unit determines that there is the non-performance state when a stat is detected in which up to the minimum number of notes are not played among the music data to be played in a predetermined time period.

15. The performance supporting apparatus according to claim 12, wherein the non-performance detecting unit determines that there is the non-performance state when either is detected of the state in which up to the minimum number of notes are not played among the music data to be played in the evaluation period set based on an identification data contained in the music data and the state in which up to the minimum number of notes are not played in a predetermined period within the evaluation period set based on the identification data.

16. A performance-support processing program for executing a procedure, which comprises:
a first step of evaluating performance of the music data in the evaluation period set in accordance with contents of music data to be performed;
a second step of detecting a non-performance state in which non of notes to be played during the evaluation period is played; and
a third step of providing support for the result of evaluation made in the first step and the non-performance state detected in the second step.

17. A performance evaluation apparatus comprising:
a performance designating unit for designating a pitch of a sound-generation event contained in music data and a sound-generation period between a time of initiating sound generation and a time of vanishing the sound generation;
a performance detecting unit for detecting a pitch of a performed musical sound and a time of initiating performance of the musical sound;
a pitch judging unit for judging whether or not the pitch of the performed musical sound detected by the performance detecting unit coincides with the pitch of the sound-generation event designated by the performance designating unit;
a timing judging unit for determining that there is a coincidence in timing, when the performance detecting unit detects the time of initiating performance within the sound-generation period designated by the performance designating unit, or when the performance designating unit designates the time of initiating sound generation within a predetermined time period after the time of initiating performance detected by the performance detecting unit, and for determining that there is no coincidence in timing, when the performance detecting unit does not detect the time of initiating performance within the sound-generation period, or when the performance designating unit does not designate the time of initiating sound generation within the predetermined time period after the time of initiating performance detected by the performance detecting unit; and
a performance evaluation unit for adding an evaluation point to the evaluation score, when the pitch judging unit determines that the pitch of the performed musical sound detected by the performance detecting unit coincides with the pitch of the sound-generation event designated by the performance designating unit and when the timing judging unit determines that there is a coincidence in timing, and for subtracting the evaluation point from the evaluation score, when the pitch judging unit determines that the pitch of the performed musical sound detected by the performance detecting unit does not coincide with the pitch of the sound-generation event designated by the performance designating unit or when the timing judging unit determines that there is no coincidence in timing.

18. The performance evaluation apparatus according to claim 17, wherein the timing judging unit judges whether or not there is a coincidence in timing for each pitch designated by the performance designating unit, when the performance designating unit designates plural pitches of sound-generation events and plural sound-generation periods.

19. The performance evaluation apparatus according to claim 17, further comprising:
a time setting unit responsive to a setting operation for setting a time period, wherein the timing judging unit determines that there is a coincidence in timing, when the performance designating unit designates the time of initiating sound generation within the time period set by the time setting unit.

20. A performance evaluation program executing a procedure which comprises:
a first step of designating a pitch of a sound-generation event contained in music data and a sound-generation period between a time of initiating sound generation and a time of vanishing the sound generation;
a second step of detecting a pitch of a performed musical sound and a time of initiating the performance;
a third step of judging whether or not the pitch of the musical sound detected in the second step coincides with the pitch of the sound-generation event designated in the first step;
a fourth step of determining that there is a coincidence in timing, when the time of initiating the performance is detected in the second step within the sound-generation period designated in the first step, or when the time of initiating sound generation is designated in the first step within a predetermined time period after the time of initiating performance detected in the second step, and determining that there is no coincidence in timing, when the time of initiating the performance is not detected in the second step within the sound-generation period designated in the first step, or when the time of initiating sound generation is not designated in the first step within the predetermined time period after the time of initiating performance detected in the second step; and
a fifth step of adding an evaluation point to the evaluation score, when it is determined in the third step that the pitch of the performed musical sound detected in the second step coincides with the pitch of the sound-generation event designated in the first step and when it is determined in the forth step that there is a coincidence in timing, and subtracting the evaluation point from the evaluation score, when it is determined in the third step that the pitch of the performed musical sound detected in the second step does not coincide with the pitch of the sound-generation event designated in the first step or when it is determined in the forth step that there is no coincidence in timing.
